(19) United States
(12) Patent Application Publication
(10) Pub. No.: US 2026/0213081 A1
(43) Pub. Date: Jul. 23, 2026

(54) Feedthrough Structures Using Solid Electrolytic Capacitor

(71) Applicant: KYOCERA AVX Components Corporation, Fountain Inn, SC (US)

(72) Inventors: Craig Nies, Travelers Rest, SC (US); Ronald Demcko, Raleigh, NC (US); Joseph Hock, Surfside Beach, SC (US)

(21) Appl. No.: 19/451,603

(22) Filed: Jan. 16, 2026

Related U.S. Application Data
(60) Provisional application No. 63/746,291, filed on Jan. 17, 2025.

(51) Int. Cl. H01G 9/012; H01G 4/35; H01G 9/028; H01G 9/04; H01G 9/052; H01G 9/15

(52) U.S. Cl. CPC H01G 9/012; H01G 4/35; H01G 9/028; H01G 9/0525; H01G 9/15; H01G 2009/05

(57) ABSTRACT

Circuits with SEFCs are provided. In one example, a circuit includes an input or an output structure configured to provide a signal or power to an active electronic component. The circuit can include a feedthrough capacitor in the input or output structure. The feedthrough capacitor can include a solid electrolytic capacitor. The solid electrolytic capacitor can include a capacitor element that includes an anode body, a dielectric that overlies the anode body, and a solid electrolyte that overlies the dielectric. The capacitor element defines opposing first and second ends and an upper surface and opposing lower surface. A first exposed anode lead portion extends from the first end of the capacitor element in a lateral direction a second exposed anode lead portion extends from the second end of the capacitor element in a lateral direction.

### RELATED APPLICATION

The present application is based upon and claims priority to U.S. Provisional Patent Application Ser. No. 63/746,291, having a filing date of Jan. 17, 2025, which is incorporated herein by reference.

### BACKGROUND

Feedthrough capacitors are used in many electrical systems to suppress electromagnetic interference (EMI) and provide noise attenuation. Feedthrough capacitors may be provided in power supply lines and in signal lines for many electronic devices. For instance, feedthrough capacitors may be used to provide for EMI suppression, broadband I/O filtering, and/or power supply line conditioning. As devices increasingly operate at higher frequencies and are exposed to high frequency noise, there is a need for feedthrough capacitors capable of delivering consistent performance over a wide frequency range.

### SUMMARY

In accordance with one example embodiment of the present disclosure, a circuit includes an input or an output structure configured to provide a signal (e.g., power signal) to an active electronic component. The circuit can include a feedthrough capacitor in the input or output structure. The feedthrough capacitor can include a solid electrolytic capacitor. The solid electrolytic capacitor can include a capacitor element that includes an anode body, a dielectric that overlies the anode body, and a solid electrolyte that overlies the dielectric. The capacitor element defines opposing first and second ends and an upper surface and opposing lower surface. A first exposed anode lead portion extends from the first end of the capacitor element in a lateral direction a second exposed anode lead portion extends from the second end of the capacitor element in a lateral direction.

In accordance with another example embodiment of the present disclosure, a circuit includes an input or an output structure configured to provide a signal (e.g., power signal) to an active electronic component. The circuit can include a feedthrough capacitor in the input or output structure. The feedthrough capacitor can include a solid electrolytic capacitor, wherein the solid electrolytic capacitor comprises a capacitor element that includes an anode body, a dielectric that overlies the anode body, and a solid electrolyte that overlies the dielectric, wherein the capacitor exhibits an S₂₁ parameter (absolute value) of from about 20 dB to about 70 dB at a frequency band ranging from 1 kHz to 1 GHz and/or impedance of from about 10 mohms to about 100 mohms at a frequency band ranging from about 1 MHz to about 100 MHz.

Other features and aspects of the present disclosure are set forth in greater detail below.

### BRIEF DESCRIPTION OF THE DRAWINGS

A full and enabling disclosure of the present disclosure, including the best mode thereof, directed to one of ordinary skill in the art, is set forth more particularly in the remainder of the specification, which makes reference to the appended drawings in which:

FIG. 1A is a side view of one embodiment of an anode body that may be used to form the solid electrolytic capacitor for use in the circuit of the present disclosure;

FIG. 1B is a side view of another embodiment of an anode body that may be used to form the solid electrolytic capacitor for use in the circuit of the present disclosure;

FIG. 1C is a side view of yet another embodiment of an anode body that may be used to form a solid electrolytic capacitor for use in the circuit of the present disclosure;

FIG. 2 is a cross-sectional side view of one embodiment of a capacitor that may be employed in the circuit of the present disclosure;

FIG. 3 is a top view of the capacitor of FIG. 2; and

FIG. 4 is an exemplary equivalent circuit that may be employed to model S₂₁ parameters for a solid electrolytic capacitor over a range of frequencies.

FIG. 5A illustrates an example bias line including a solid electrolytic feedthrough capacitor (SEFC) according to embodiments of the present disclosure.

FIG. 5B illustrates example performance characteristics associated with FIG. 5A.

FIG. 6 illustrates an example implementation of an SEFC according to embodiments of the present disclosure.

FIG. 7 illustrates another example implementation of an SEFC according to embodiments of the present disclosure.

FIG. 8 illustrates another example implementation of an SEFC according to embodiments of the present disclosure.

FIG. 9 illustrates another example implementation of an SEFC according to embodiments of the present disclosure.

FIG. 10 illustrates another example implementation of an SEFC according to embodiments of the present disclosure.

FIG. 11 illustrates an example power system including an SEFC according to embodiments of the present disclosure.

FIG. 12 illustrates another example power system including an SEFC according to embodiments of the present disclosure.

FIG. 13 illustrates another example power system including an SEFC according to embodiments of the present disclosure.

FIGS. 14-15 illustrate example implementations of an SEFC according to embodiments of the present disclosure.

FIG. 16 illustrates an example display system including an SEFC according to embodiments of the present disclosure.

FIG. 17 illustrates an example power conversion system including an SEFC according to embodiments of the present disclosure.

FIG. 18 illustrates an example amplifier circuit including an SEFC according to embodiments of the present disclosure.

FIG. 19 illustrates an example voltage regulation system including an SEFC according to embodiments of the present disclosure.

FIG. 20 illustrates an example frequency control circuit including an SEFC according to embodiments of the present disclosure.

FIG. 21 illustrates an example phase-locked loop circuit including an SEFC according to embodiments of the present disclosure.

FIG. 22 illustrates example configurations of an SEFC according to embodiments of the present disclosure.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present disclosure, which broader aspects are embodied in the exemplary construction.

### 1. Overview

Example aspects of the present disclosure are directed to circuits (e.g., electronic circuits) and electrical systems employing a feedthrough capacitor in a signal line or power supply line. The feedthrough capacitor is a solid electrolytic capacitor that exhibits consistent performance across a wide range of frequencies with low inductance. The feedthrough capacitor may exhibit low equivalent series inductance and low impedance across a wide frequency range, such as from about 1 kHz to about 100 MHz, such as from about 1 MHz to about 100 MHz. In some examples, the feedthrough capacitor exhibits an S₂₁ parameter (absolute value) of from about 20 dB to about 70 dB at a frequency band ranging from about 1 kHz to about 1 GHz and/or impedance of from about 10 mohms to about 100 mohms at a frequency band ranging from about 1 MHz to about 100 MHz. As used herein, the use of the term “about” in conjunction with a numerical value refers to within 20% of the stated numerical value.

In some examples, the feedthrough capacitor may be a solid electrolytic feedthrough capacitor (SEFC). The SEFC may include a capacitor element that includes an anode body, a dielectric that overlies the anode body, and a solid electrolyte that overlies the dielectric. In some examples, the anode body includes tantalum and the dielectric includes tantalum pentoxide. However, other suitable materials may be used as the anode body and dielectric without deviating from the scope of the present disclosure. Details concerning an example solid electrolytic capacitor used as a feedthrough capacitor according to examples of the present disclosure are provided in more detail in Section II below.

The feedthrough capacitor may be used to condition signals passing through a signal line of a circuit or to condition power used to power an electronic circuit including one or more active components (e.g., transistors, processors, controllers, active switches, amplifiers, ADC converters, etc.). An active component may be a component that can control the flow of electrical signals or power (e.g., current, voltage), amplify signals, control or generate signal frequency, etc. An active component may require an external power source to operate. In some embodiments, the feedthrough capacitor may be used as a filtering capacitor for a power conversion circuit, such as a filter for a buck converter, boost converter, inverter, or other suitable power conversion topology.

Aspects of the present disclosure provide a number of technical effects and benefits. For instance, the low inductance and low impedance of the feedthrough capacitor across a wide frequency range allows the feedthrough capacitor to replace many passive components provided in a typical feedthrough networks for signal lines and power lines in an electrical system. In some examples, the feedthrough capacitor according to examples of the present disclosure may reduce the need to couple multiple capacitors in parallel to achieve desired performance.

For instance, some feedthrough capacitive networks may require the use of multiple ceramic capacitors coupled in parallel to achieve desired capacitance and low impedance bandwidth, leading to issues such as anti-resonance that must be addressed with other components. However, the SEFC according to examples of the present disclosure may provide desired feedthrough capacitor performance across a wide frequency range, allowing for simplification of the feedthrough network for many applications. In some cases, reducing the size of the filtering circuit and/or reducing the number of components may allow for moving the bulk capacitance nearer to the load, improving the efficiency of the circuit. The SEFC may reduce switching time by reducing inductance and/or reducing distance to load.

The SEFC according to examples of the present disclosure may be used in a variety of applications. In some examples, the feedthrough capacitor may be used, for instance, in a bias line for an active component, such as a transistor. In some examples, the SEFC may be used for signal conditioning or power line conditioning in RF circuits, such as in power or bias lines for RF amplifiers.

In some examples, the SEFC may be used as part of a power supply line for a processor (e.g., microprocessor) and/or controller. In some examples, the SEFC may be used as part of complex power distribution network (e.g., including one or more point of load converters) for powering integrated circuits, FPGAs, processor cores, (e.g., CPU cores, GPU cores), etc.

In some examples, the SEFC may be used at least as part of filtering for power supply lines for power systems, such as filtering for all power conversion topologies, such as buck converters, boost converters, inverters, etc. In some examples, the SEFC may be used for low frequency power filtering for analog and/or digital interfaces (e.g., for an analog-to-digital converter). In some examples, the SEFC may be used to provide power for driver circuits for a variety of applications (e.g., LED, LCD, etc.). In some examples, the SEFC may be used for voltage regulator filtering.

In some examples, the SEFC may be used for power line filtering and/or conditioning on a frequency control circuit. In some examples, the SEFC may be used in phased locked loop (PLL) circuits to reduce noise.

The example applications listed above are provided for purposes of illustration and discussion. Those of ordinary skill in the art, using the disclosures provided herein, will understand that the SEFC according to examples of the present disclosure may be used in a variety of applications and/or electrical circuits without deviating from the scope of the present disclosure.

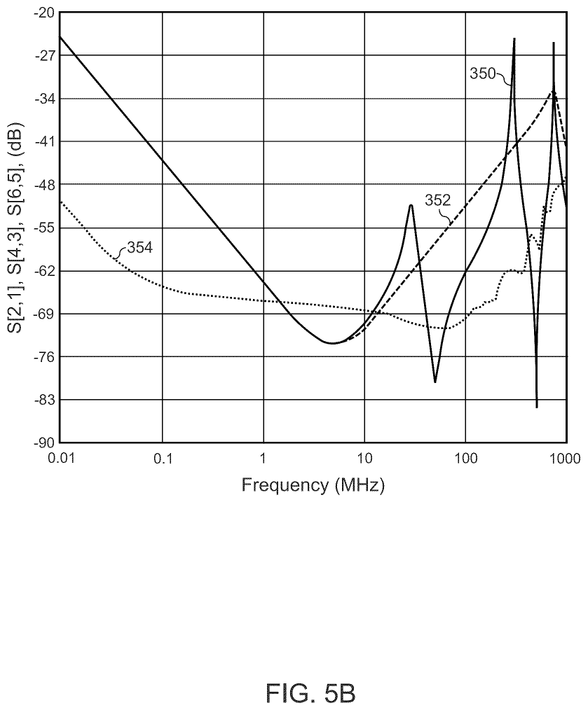

Certain example applications of the SEFC are provided in FIGS. 5-22.

### II. Solid Electrolytic Capacitor

As indicated above, example aspects of the present disclosure employ a solid electrolytic capacitor having certain unique characteristics so that it is capable of replacing one or more conventional passive components (e.g., multi-layered ceramic capacitors, resistors, etc.) within a circuit. More particularly, through selective control over its particular configuration, the solid electrolytic capacitor may exhibit low equivalent series inductance (“ESL”) values, such as about 1 nanohenry or less, in some embodiments about 750 picohenries or less, in some embodiments about 350 picohenries or less, in some embodiments from about 1 femtohenry to about 100 picohenries, and in some embodiments, from about 50 femtohenries to about 10 picohenries. The low ESL values may also be characterized by a low impedance value, which is a reflection of parasitic inductance. The impedance may, for example, be about 1 ohm or less at frequency ranges of about 1 kHz to about 1 GHZ, such as about 1 kHz to about 100 MHz in some embodiments about 500 mohms or less, in some embodiments about 200 mohms or less, and in some embodiments, from about 10 mohms to about 100 mohms. Such low ESL and impedance values may also be exhibited even a broad range of frequencies, such as from 1 kHz to about 100 MHz, in some embodiments from about 100 KHz to about 100 MHz, and in some embodiments, from about 1 MHz to about 100 MHz. Reducing parasitic inductance over a wide range of frequencies can contribute to good performance, in particular good decoupling performance, especially under high-speed transient conditions.

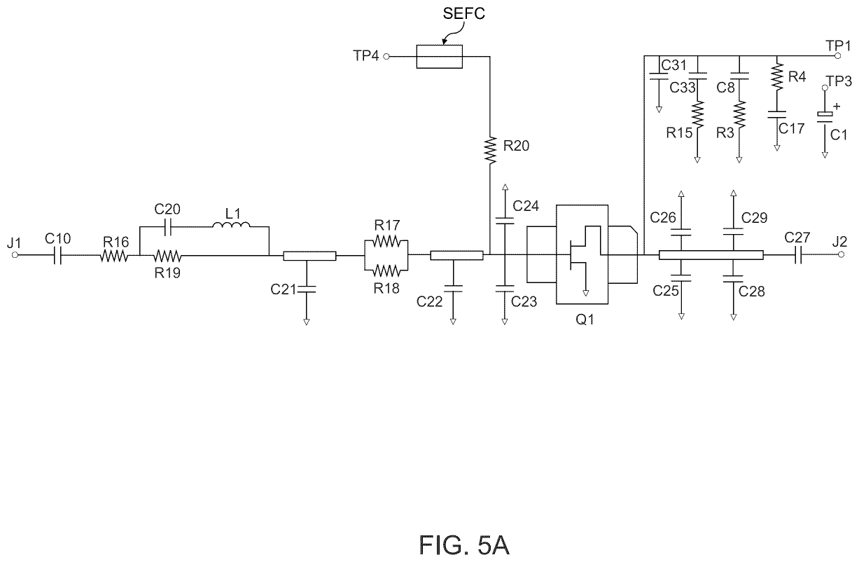

The capacitor may also exhibit excellent DC power filtering, such as illustrated by excellent attenuation over a broad range of frequencies. As known in the art, insertion loss measures power transfer between terminations, if the power increases, gain is exhibited, where if power is decreased between the terminals, attenuation is exhibited. Thus, the capacitor may exhibit high attenuation over a broad band of frequencies ranging from 1 kHz to 1 GHZ, thus allowing a broad range of frequencies to be well filtered. Over this broad range of frequencies ranging, for instance, the capacitor may exhibit attenuation (absolute value of S₂₁ parameter) of about 15 dB or more, in some embodiments about 20 dB or more, and in some embodiments, from about 20 dB to about 70 dB, such as about 40 dB. The S₂₁ parameter may be measured using a Vector Network Analyzer over a variety of frequencies and may also be modeled using the equivalent circuit shown in FIG. 4. At low frequencies ranging from about 10 KHz to about 100 kHz, for example, the capacitor may exhibit attenuation (absolute value of S₂₁ parameter) of about 30 dB or more, in some embodiments about 50 dB or more, and in some embodiments, from about 50 dB to about 70 dB. Likewise, at high frequencies ranging from about 1 MHz to about 1 GHZ, and in some cases, from about 10 MHz to about 1 GHz, the capacitor may exhibit attenuation (absolute value of S₂₁ parameter) of about 20 dB or more, in some embodiments about 25 dB or more, in some embodiments about 30 dB or more, and in some embodiments, from about dB to about 70 dB. Furthermore, the capacitor may perform consistently across a wide range of temperatures. For instance, in one embodiment, the capacitor may vary about 5 dB or less over a large temperature range, such as a change in temperature of about 25° C. or greater, in some embodiments about 50° C., or greater, and in some embodiments, about 70° C. or greater.

The capacitor may also exhibit other beneficial electrical properties. For example, the capacitor may also exhibit low equivalent series resistance (“ESR”) values, such as about 800 mohms or less, in some embodiments about 600 mohms or less, in some embodiments about 500 mohms or less, in some embodiments about 350 mohms or less, in some embodiments from about 0.01 to about 250 mohms, and in some embodiments, from about 0.1 to about 150 mohms, such as determined using a HP4284 A LCR meter with Kelvin Leads with 0 volt DC bias and 10 mVAC signals, operating frequency of 100 kHz, and temperature of 23° C.+2° C. Notably, the low ESR values can still remain stable even at high temperatures and/or high humidity levels, which can expand the potential applications within which the circuit of the present disclosure may be employed. For example, the resulting the capacitor may exhibit ESR values within the ranges noted above even after being exposed to a temperature of from about 80° C. or more, in some embodiments from about 85° C. to about 180° C., and in some embodiments, from about 85° C. to about 150° C. (e.g., about 85° C., 105° C., 125° C., or 150° C.) and/or a relative humidity level of about 40% or more, in some embodiments about 45% or more, in some embodiments about 50% or more, and in some embodiments, about 70% or more (e.g., about 85% to 100%) for a substantial period of time as noted above. Relative humidity may, for instance, be determined in accordance with ASTM E337-02, Method A (2007). The time period for exposure to the high temperature and/or humidity level may be about 100 hours or more, in some embodiments from about 150 hours to about 3,000 hours, and in some embodiments, from about 200 hours to about 2,500 hours (e.g., 250, 500, 750, or 1,000 hours). For example, the ESR of the capacitor after being exposed to a high temperature (e.g., about 85° C.) and/or humidity level (e.g., about 85%) for 500 hours may be about 1,500 mohms or less, in some embodiments about 1,000 mohms or less, in some embodiments about 800 mohms or less, in some embodiments about 600 mohms or less, in some embodiments from about 0.01 to about 500 mohms, and in some embodiments, from about 0.1 to about 200 mohms, measured at an operating frequency of 100 KHz and temperature of 23° C. Likewise, the ratio of the ESR of the capacitor after being exposed to a high temperature (e.g., about 85° C.) and/or humidity level (e.g., about 85%) for 500 hours to the initial DCL of the capacitor (e.g., at about 23° C.) may be about 10 or less, in some embodiments about 5 or less, in some embodiments about 3 or less, in some embodiments about 2 or less, and in some embodiments, from about 0.9 to about 1.5.

The capacitor may also exhibit a low leakage current (“DCL”) over a wide variety of conditions. Furthermore, after being subjected to an applied voltage (e.g., 16 volts) at a temperature of about 23° C. for a certain period of time (e.g., from about 30 minutes to about 20 hours, in some embodiments from about 1 hour to about 18 hours, and in some embodiments, from about 4 hours to about 16 hours), the capacitor may exhibit a DCL of about 10 microamps (“μA”) or less, in some embodiments about 5 μA or less, in some embodiments about 1 μA or less, and in some embodiments, from about 0.01 to about 5 μA, such as determined using a leakage test meter (YHP4140B) at a temperature of 23° C.+2° C., with 1 kOhm resistor to limit charging current and at the rated voltage (e.g., 2.5 V) after a minimum of 5 minutes. In one embodiment, the DCL of the capacitor after being exposed to a high temperature (e.g., about 85° C.) and/or humidity level (e.g., about 85%) for 500 hours may also be about 10 μA or less, in some embodiments about 8 μA or less, in some embodiments about 6 μA or less, and in some embodiments, from about 0.1 to about 5 μA. Likewise, the ratio of the DCL of the capacitor after being exposed to a high temperature (e.g., about 85° C.) and/or humidity level (e.g., about 85%) for 500 hours to the initial DCL of the capacitor (e.g., at about 23° C.) may be about 20 or less, in some embodiments about 15 or less, in some embodiments about 10 or less, in some embodiments about 5 or less, and in some embodiments, from about 0.9 to about 4.

The capacitor may also exhibit a capacitance of about 30 nanoFarads per square centimeter (“nF/cm²”) or more, in some embodiments about 100 nF/cm² or more, in some embodiments from about 200 to about 3,000 nF/cm², and in some embodiments, from about 400 to about 2,000 nF/cm², such as determined with Kelvin leads at a 2.2 volt DC bias and 0.5 volt peak-to-peak sinusoidal signal, a frequency of 120 Hz, and at a temperature of 23° C. The actual capacitance may vary, such as from about 10 μF to about 1,000 μF, in some embodiments from about 50 μF to about 500 μF, and in some embodiments, from about 60 μF to about 250 μF. Similar to the DCL and ESR values, the capacitance can also remain stable at the high temperature and/or humidity level ranges noted above. In one embodiment, for example, the ratio of the capacitance value of the capacitor after being exposed to a high temperature (e.g., about 85° C.) and/or humidity level (e.g., about 85%) for 500 hours to the initial capacitance value of the capacitor (e.g., at about 23° C.) may be about 3.0 or less, in some embodiments about 2.0 or less, in some embodiments about 1.8 or less, in some embodiments about 1.6 or less, and in some embodiments, from about 0.9 to about 1.3.

It is also believed that the dissipation factor of the capacitor may be maintained at relatively low levels. The dissipation factor generally refers to losses that occur in the capacitor and is usually expressed as a percentage of the ideal capacitor performance. For example, the dissipation factor of the capacitor is typically about 250% or less, in some embodiments about 200% or less, and in some embodiments, about 50% or less as determined at a frequency of 120 Hz. In some example embodiments of the present invention, the dissipation factor is typically from about 0.5% to about 25%, in some embodiments from about 0.8% to about 10%, and in some embodiments, from about 1% to about 5%, as determined at a frequency of 120 Hz. The dissipation factor may be determined using a Keithley 3330 Precision LCZ meter with Kelvin Leads with 2.2 volt DC bias and a 0.5 volt peak to peak sinusoidal signal. The operating frequency may be 120 Hz and the temperature may be 23° C.±2° C.

To help achieve the desirable properties noted above, the capacitor may contain a capacitor element that includes an anode body, a dielectric that overlies the anode body, and a solid electrolyte that overlies the dielectric. The capacitor element may likewise contain opposing first and second ends and an opposing upper surface and lower surface, and may contain multiple anode lead portions that extend from the ends of the capacitor element.

### A. Anode Body

The anode body may be formed in a variety of ways as is known in the art. For example, the anode body may be formed from a sintered powder, foil, mesh, sheet, plate, etc. Regardless, the anode body typically contains a valve metal (i.e., metal that is capable of oxidation) or valve metal-based compound, such as tantalum, niobium, aluminum, hafnium, titanium, alloys thereof, oxides thereof, nitrides thereof, and so forth. In one embodiment, for instance, the anode body is formed from a tantalum powder. The specific charge of the powder typically may generally vary from about 5,000 to about 800,000 microFarads*Volts per gram (“μF*V/g”) depending on the desired application. For instance, in certain embodiments, a high charge powder may be employed that has a specific charge of from about 100,000 to about 600,000 μF*V/g, in some embodiments from about 120,000 to about 500,000 μF*V/g, and in some embodiments, from about 150,000 to about 400,000 μF*V/g. In other embodiments, a low charge powder may be employed that has a specific charge of from about 5,000 to about 100,000 μF*V/g, in some embodiments from about 8,000 to about 90,000 F*V/g, and in some embodiments, from about 10,000 to about 80,000 μF*V/g. As is known in the art, the specific charge may be determined by multiplying capacitance by the anodizing voltage employed, and then dividing this product by the weight of the anodized electrode body.

The powder may be a free-flowing, finely divided powder that contains primary particles. The primary particles of the powder generally have a median size (D50) of from about 5 to about 250 nanometers, in some embodiments from about 10 to about 200 nanometers, and in some embodiments, from about 20 to about 150 nanometers, such as determined using a laser particle size distribution analyzer made by BECKMAN COULTER Corporation (e.g., LS-230), optionally after subjecting the particles to an ultrasonic wave vibration of 70 seconds. The primary particles typically have a three-dimensional granular shape (e.g., nodular or angular). Such particles typically have a relatively low “aspect ratio”, which is the average diameter or width of the particles divided by the average thickness (“D/T”). For example, the aspect ratio of the particles may be about 4 or less, in some embodiments about 3 or less, and in some embodiments, from about 1 to about 2. In addition to primary particles, the powder may also contain other types of particles, such as secondary particles formed by aggregating (or agglomerating) the primary particles. Such secondary particles may have a median size (D50) of from about 1 to about 500 micrometers, and in some embodiments, from about 10 to about 250 micrometers.

Agglomeration of the particles may occur by heating the particles and/or through the use of a binder. For example, agglomeration may occur at a temperature of from about 0° C. to about 40° C., in some embodiments from about 5° C. to about 35° C., and in some embodiments, from about 15° C. to about 30° C. If desired, the powder may also be doped with sinter retardants in the presence of a dopant, such as aqueous acids (e.g., phosphoric acid). The powder may also be subjected to one or more deoxidation treatments. For example, the powder may be exposed to a getter material (e.g., magnesium), such as described in U.S. Pat. No. 4,960,471. The resulting powder may have certain characteristics that enhance its ability to be formed into a capacitor anode. For example, the powder typically has a specific surface area of from about 0.5 to about 10.0 m²/g, in some embodiments from about 0.7 to about 5.0 m²/g, and in some embodiments, from about 2.0 to about 4.0 m²/g. Likewise, the bulk density of the powder may be from about 0.1 to about 0.8 grams per cubic centimeter (g/cm³), in some embodiments from about 0.2 to about 0.6 g/cm³, and in some embodiments, from about 0.4 to about 0.6 g/cm³.

Once the powder is formed, it may be generally compacted or pressed to form a pellet using any conventional powder press device. For example, a press mold may be employed that is a single station compaction press containing a die and one or multiple punches. Alternatively, anvil-type compaction press molds may be used that use only a die and single lower punch. Single station compaction press molds are available in several basic types, such as cam, toggle/knuckle and eccentric/crank presses with varying capabilities, such as single action, double action, floating die, movable platen, opposed ram, screw, impact, hot pressing, coining or sizing. The powder is typically pressed to a density of from about 0.5 to about 20 g/cm³, in some embodiments from about 1 to about 15 g/cm³, and in some embodiments, from about 2 to about 10 g/cm³.

Any binder may be removed after pressing by heating the pellet under vacuum at a certain temperature (e.g., from about 150° C. to about 500° C.) for several minutes. Alternatively, the binder may also be removed by contacting the pellet with an aqueous solution, such as described in U.S. Pat. No. 6,197,252 to Bishop, et al. After binder removal, the anode body may be subjected to an optional deoxidation process. In one embodiment, for example, the deoxidation process includes exposing the anode body to a getter material (e.g., magnesium, titanium, etc.) that is capable of removing oxygen from the anode body by chemical reaction, adsorption, etc. After optional deoxidation, the anode body may be sintered to form a porous, integral mass. The anode body is typically sintered at a temperature of from about 700° C. to about 1,600° C., in some embodiments from about 800° C. to about 1,500° C., and in some embodiments, from about 900° C. to about 1,200° C., for a time of from about 5 minutes to about 100 minutes, and in some embodiments, from about 8 minutes to about 15 minutes. This may occur in one or more steps. If desired, sintering may occur in an atmosphere that limits the transfer of oxygen atoms to the anode. For example, sintering may occur in a reducing atmosphere, such as in a vacuum, inert gas, hydrogen, etc.

As indicated above, the capacitor may contain multiple anode lead portions that are electrically connected to respective anode terminations. The anode lead portions may be formed as part of a single anode lead (e.g., opposing ends) or as part of separate anode leads. The anode lead(s) may have any desired shape and size and may be in the form of a wire, sheet, etc. Typically, the anode lead(s) extend in a longitudinal direction from the anode body and are formed from any electrically conductive material, such as tantalum, niobium, aluminum, hafnium, titanium, etc., as well as electrically conductive oxides and/or nitrides of thereof. Connection of the lead(s) to the anode body may be accomplished using any known technique, such as by welding the leads to the body or embedding the leads within the anode body during formation (e.g., prior to compaction and/or sintering).

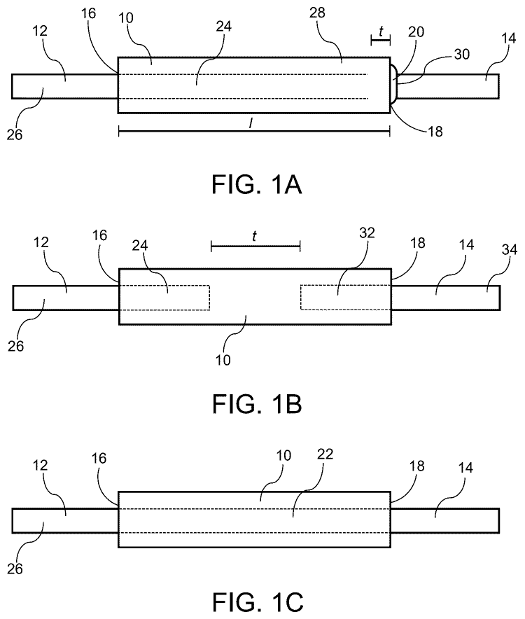

Referring to FIG. 1A, one embodiment of an anode body 10 is shown that has a first anode lead 12 having an embedded portion 24 positioned within the anode body and an exposed first anode lead portion 26 extending from a first end 16 of the anode body 10. A second exposed anode lead portion 14 is likewise connected (e.g., by weld 20) to a second end 18 of the anode body 10. As shown in FIG. 1A, the second exposed anode lead portion 14 is formed as part of a separated, second anode lead extending from a second end 18 of the anode body. Of course, as shown in FIG. 1C, first exposed anode lead portion 26 and second exposed anode lead portion 14 may also be defined by opposing portions of a single, continuous anode lead 22 that extends through both ends 16 and 18 of the anode body 10. Regardless, it is typically desired that the exposed anode lead portions extend from opposing ends of the anode body in generally the same plane. Referring again to FIG. 1A, a gap may optionally exist between the embedded end of the first anode lead and the end of the anode body so that the electrical connection between the first and second anode leads is provided through the sintered anode body. In FIG. 1A, for instance, this gap may be defined as a distance “t” between the end 18 of the anode body and the embedded end 28 of the anode lead, which typically ranges from about 0.2 to about 5 millimeters, in some embodiments from about 0.4 to about 4 millimeters, and in some embodiments, from about 0.5 to about 2 millimeters. The length of the anode “I” may likewise range from about 1.5 to about 6 millimeters, and in some embodiments, from about 2 to about 5 millimeters. In such embodiments, the ratio of the distance “t” to the length “I” may also range from about 0.1 to about 0.8, in some embodiments from about 0.2 to about 0.7, and in some embodiments, from about 0.3 to about 0.6.

Another embodiment is shown in FIG. 1B in which an anode body 10 has a first anode lead 12 having an embedded portion 24 positioned within the anode body and an exposed first anode lead portion 26 extending from a first end 16 of the anode 10. A second anode lead 14 having an embedded portion 32 positioned within the anode body and an exposed second anode lead portion 34 extending from a second end 18 of the anode body 10. Thus, in this embodiment, the need for a welded portion for the second anode lead is not required. Similar to the embodiment noted above, a gap “t” may optionally exist between the embedded end of the first anode lead and the embedded end of the second anode lead, which may be within the ranges noted above.

### B. Dielectric

The anode body is typically coated with a dielectric. For example, the dielectric may be formed by anodically oxidizing (“anodizing”) the sintered anode body so that a dielectric layer is formed over and/or within the anode body. For example, a tantalum (Ta) anode may be anodized to tantalum pentoxide (Ta₂O₅). Typically, anodization is performed by initially applying a solution to the anode, such as by dipping anode into the electrolyte. A solvent is generally employed, such as water (e.g., deionized water). To enhance ionic conductivity, a compound may be employed that is capable of dissociating in the solvent to form ions. Examples of such compounds include, for instance, acids, such as described below with respect to the electrolyte. For example, an acid (e.g., phosphoric acid) may constitute from about 0.01 wt. % to about 5 wt. %, in some embodiments from about 0.05 wt. % to about 0.8 wt. %, and in some embodiments, from about 0.1 wt. % to about 0.5 wt. % of the anodizing solution. If desired, blends of acids may also be employed.

A current may be passed through the anodizing solution to form the dielectric layer. The value of the formation voltage manages the thickness of the dielectric layer. For example, the power supply may be initially set up at a galvanostatic mode until the required voltage is reached. Thereafter, the power supply may be switched to a potentiostatic mode to ensure that the desired dielectric thickness is formed over the entire surface of the anode. Of course, other known methods may also be employed, such as pulse or step potentiostatic methods. The forming voltage employed during anodization is generally about 20 volts or more, in some embodiments about 30 volts or more, in some embodiments about 35 volts or more, and in some embodiments, from about 35 to about 70 volts, and at temperatures ranging from about 10° C. or more, in some embodiments from about 20° C. to about 200° C., and in some embodiments, from about 30° C. to about 100° C. The resulting dielectric layer may be formed on a surface of the anode and within its pores.

By selectively controlling the particular manner in which the anode body is formed, the resulting capacitor can exhibit a high degree of dielectric strength, which can improve capacitance stability. The “dielectric strength” generally refers to the ratio of the “breakdown voltage” of the capacitor (voltage at which the capacitor fails in volts, “V”) to the thickness of the dielectric (in nanometers, “nm”). The capacitor typically exhibits a dielectric strength of about 0.4 V/nm or more, in some embodiments about 0.45 V/nm or more, in some embodiments about 0.5 V/nm or more, in some embodiments from about 0.55 to about 1 V/nm, and in some embodiments, from about 0.6 to about 0.9 V/nm. The capacitor may, for example, exhibit a relatively high breakdown voltage, such as about 30 volts or more, in some embodiments about 35 volts or more, in some embodiments about 50 volts or more, in some embodiments about 65 volts or more, in some embodiments about 85 volts or more, in some embodiments about 90 volts or more, in some embodiments about 95 volts or more, and in some embodiments, from about 100 volts to about 300 volts, such as determined by increasing the applied voltage in increments of 3 volts until the leakage current reaches 1 mA. While its thickness can generally vary depending on the particular location of the anode body, the “dielectric thickness” for purposes of determining dielectric strength is generally considered as the greatest thickness of the dielectric, which typically ranges from about 50 to about 500 nm, in some embodiments from about 80 to about 350 nm, and in some embodiments, from about 100 to about 300 nm. The dielectric thickness may be measured using Zeiss Sigma FESEM at 20,000× to 50,000× magnification, wherein the sample is prepared by cutting a finished part in plane perpendicular to the longest dimension of the finished part, and the thickness is measured at sites where the cut is perpendicular through the dielectric layer.

### C. Solid Electrolyte

A solid electrolyte typically overlies the dielectric, as well as any other optional intervening layers. The total thickness of the solid electrolyte is typically from about 1 to about 50 μm, and in some embodiments, from about 5 to about 20 μm. The solid electrolyte typically includes one or more layers of a conductive polymer (e.g., polyheterocycles, such as polypyrroles, polythiophenes, polyanilines, etc., polyacetylenes, poly-p-phenylenes, polyphenolates, etc.). Thiophene polymers are particularly suitable for use in the solid electrolyte. In certain embodiments, for instance, a thiophene polymer may be employed that has repeating units of the following formula (I):

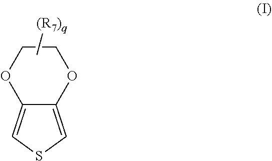

wherein,
R₇ is a linear or branched, C₁ to C₁₈ alkyl radical (e.g., methyl, ethyl, n- or iso-propyl, n-, iso-, sec- or tert-butyl, n-pentyl, 1-methylbutyl, 2-methylbutyl, 3-methylbutyl, 1-ethylpropyl, 1,1-dimethylpropyl, 1,2-dimethylpropyl, 2,2-dimethylpropyl, n-hexyl, n-heptyl, n-octyl, 2-ethylhexyl, n-nonyl, n-decyl, n-undecyl, n-dodecyl, n-tridecyl, n-tetradecyl, n-hexadecyl, n-octadecyl, etc.); C₅ to C₁₂ cycloalkyl radical (e.g., cyclopentyl, cyclohexyl, cycloheptyl, cyclooctyl, cyclononyl, cyclodecyl, etc.); C₆ to C₁₄ aryl radical (e.g., phenyl, naphthyl, etc.); C₇ to C₁₈ aralkyl radical (e.g., benzyl, o-, m-, p-tolyl, 2,3-, 2,4-, 2,5-, 2-6, 3-4-, 3,5-xylyl, mesityl, etc.); and q is an integer from 0 to 8, in some embodiments, from 0 to 2, and in one embodiment, 0.

In one particular embodiment, “q” is 0. One commercially suitable example of 3,4-ethylenedioxthiophene is available from Heraeus under the designation Clevios™ M. Other suitable monomers are also described in U.S. Pat. No. 5,111,327 to Blohm, et al. and 6,635,729 to Groenendaal, et al. Derivatives of these monomers may also be employed that are, for example, dimers or trimers of the above monomers. Higher molecular derivatives, i.e., tetramers, pentamers, etc. of the monomers are suitable for use in the present disclosure. The derivatives may be made up of identical or different monomer units and used in pure form and in a mixture with one another and/or with the monomers. Oxidized or reduced forms of these precursors may also be employed.

To form the polymer, the precursor monomer may be polymerized in the presence of an oxidative catalyst (e.g., chemically polymerized). The oxidative catalyst typically includes a transition metal cation, such as iron (III), copper (II), chromium (VI), cerium (IV), manganese (IV), manganese (VII), or ruthenium (III) cations, and etc. A dopant may also be employed to provide excess charge to the conductive polymer and stabilize the conductivity of the polymer. The dopant typically includes an inorganic or organic anion, such as an ion of a sulfonic acid (e.g., p-toluene sulfonate). In certain embodiments, the oxidative catalyst has both a catalytic and doping functionality in that it includes a cation (e.g., transition metal) and an anion (e.g., sulfonic acid). For example, the oxidative catalyst may be a transition metal salt that includes iron (III) cations, such as iron (III) halides (e.g., FeCl₃) or iron (III) salts of other inorganic acids, such as Fe(ClO₄)₃ or Fe₂ (SO₄)₃ and the iron (III) salts of organic acids and inorganic acids comprising organic radicals. Examples of iron (III) salts of inorganic acids with organic radicals include, for instance, iron (III) salts of sulfuric acid monoesters of C₁ to C₂₀ alkanols (e.g., iron (III) salt of lauryl sulfate). Likewise, examples of iron (III) salts of organic acids include, for instance, iron (III) salts of C₁ to C₂₀ alkane sulfonic acids (e.g., methane, ethane, propane, butane, or dodecane sulfonic acid); iron (III) salts of aliphatic perfluorosulfonic acids (e.g., trifluoromethane sulfonic acid, perfluorobutane sulfonic acid, or perfluorooctane sulfonic acid); iron (III) salts of aliphatic C₁ to C₂₀ carboxylic acids (e.g., 2-ethylhexylcarboxylic acid); iron (III) salts of aliphatic perfluorocarboxylic acids (e.g., trifluoroacetic acid or perfluorooctane acid); iron (III) salts of aromatic sulfonic acids optionally substituted by C₁ to C₂₀ alkyl groups (e.g., benzene sulfonic acid, o-toluene sulfonic acid, p-toluene sulfonic acid, or dodecylbenzene sulfonic acid); iron (III) salts of cycloalkane sulfonic acids (e.g., camphor sulfonic acid); and so forth. Mixtures of these above-mentioned iron (III) salts may also be used. Iron (III)-p-toluene sulfonate, iron (III)-o-toluene sulfonate, and mixtures thereof, are particularly suitable. One commercially suitable example of iron (III)-p-toluene sulfonate is available from Heraeus under the designation Clevios™ C.

In the process described above, the conductive polymers are generally formed “in situ” on the anode body. Of course, this is by no means required. In other embodiments, for example, the conductive polymer may be pre-polymerized. In one embodiment, for example, the pre-polymerized polymer is an intrinsically conductive polymer that has a positive charge located on the main chain that is at least partially compensated by anions covalently bound to the polymer. Such polymers may, for example, have a relatively high specific conductivity, in the dry state, of about 1 Siemen per centimeter (“S/cm”) or more, in some embodiments about 10 S/cm or more, in some embodiments about 25 S/cm or more, in some embodiments about 40 S/cm or more, and in some embodiments, from about 50 to about 500 S/cm. One example of a suitable intrinsically conductive thiophene polymer may have repeating units of the following formula (III):

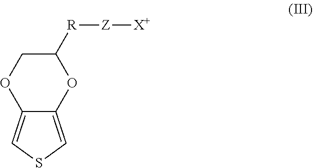

wherein,
R is (CH₂)ₐ—O—(CH₂)_{b}-L, where L is a bond or HC([CH₂]_{c} CH);
a is from 0 to 10, in some embodiments from 0 to 6, and in some embodiments, from 1 to 4 (e.g., 1);
b is from 1 to 18, in some embodiments from 1 to 10, and in some embodiments, from 2 to 6 (e.g., 2, 3, 4, or 5);
c is from 0 to 10, in some embodiments from 0 to 6, and in some embodiments, from 1 to 4 (e.g., 1);
Z is an anion, such as SO₃⁻, C(O)O⁻, BF₄⁻, CF₃SO₃⁻, SbF₆⁻, N(SO₂CF₃)₂⁻, C₄H₃O₄⁻, ClO₄⁻, etc.;
X is a cation, such as hydrogen, an alkali metal (e.g., lithium, sodium, rubidium, cesium or potassium), ammonium, etc.

In one particular embodiment, Z in formula (III) is a sulfonate ion such that the intrinsically conductive polymer contains repeating units of the following formula (IV):

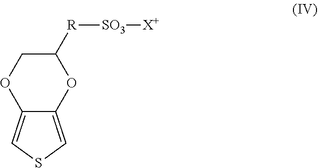

wherein, R and X are defined above. In formula (III) or (IV), a is preferably 1 and b is preferably 3 or 4. Likewise, X is preferably sodium or potassium.

If desired, the polymer may be a copolymer that contains other types of repeating units. In such embodiments, the repeating units of formula (III) typically constitute about 50 mol. % or more, in some embodiments from about 75 mol. % to about 99 mol. %, and in some embodiments, from about 85 mol. % to about 95 mol. % of the total amount of repeating units in the copolymer. Of course, the polymer may also be a homopolymer to the extent that it contains 100 mol. % of the repeating units of formula (III). Specific examples of such homopolymers include poly(4-(2,3-dihydrothieno-[3,4-b][1,4]dioxin-2-ylmethoxy)-1-butane-sulphonic acid, salt) and poly(4-(2,3-dihydrothieno-[3,4-b][I,4]dioxin-2-ylmethoxy)-I-propanesulphonic acid, salt).

In another embodiment, the intrinsically conductive polymer has repeating thiophene units of the following general formula (V):

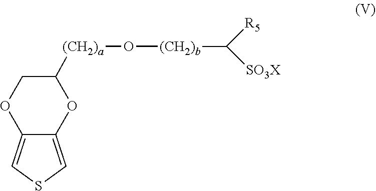

wherein,
a and b are as defined above;
R₅ is an optionally substituted C₁-C₆ linear or branched alkyl group (e.g., methyl) or a halogen atom (e.g., fluorine);
X is a hydrogen atom, an alkali metal (e.g., Li, Na, or K), NH(R¹)₃, or HNC₅H₅, wherein R¹ is each independently a hydrogen atom or an optionally substituted C₁-C₆ alkyl group.

Specific examples of thiophene compounds used to form such repeating are described in U.S. Pat. No. 9,718,905 and may include, for instance, sodium 3-[(2,3-dihydrothieno[3,4-b][1,4]dioxin-2-yl) methoxy]-1-methyl-1-propanesulfonate, sodium 3-[(2,3-dihydrothieno[3,4-b]-[1,4]dioxin-2-yl) methoxy]-1-ethyl-1-propanesulfonate, sodium 3-[(2,3-dihydrothieno[3,4-b]-[1,4]dioxin-2-yl) methoxy]-1-propyl-1-propane-sulfonate, sodium 3-[(2,3-dihydrothieno[3,4-b]-[1,4]dioxin-2-yl) methoxy]-1-butyl-1-propanesulfonate, sodium 3-[(2,3-dihydrothieno[3,4-b]-[1,4]dioxin-2-yl) methoxy]-1-pentyl-1-propane-sulfonate, sodium 3-[(2,3-dihydrothieno[3,4-b]-[1,4]dioxin-2-yl) methoxy]-1-hexyl-1-propanesulfonate, sodium 3-[(2,3-dihydrothieno[3,4-b]-[1,4]dioxin-2-yl) methoxy]-1-isopropyl-1-propanesulfonate, sodium 3-[(2,3-dihydrothieno[3,4-b]-[1,4]dioxin-2-yl) methoxy]-1-isobutyl-1-propanesulfonate, sodium 3-[(2,3-dihydrothieno[3,4-b]-[1,4]dioxin-2-yl) methoxy]-1-isopentyl-1-propanesulfonate, sodium 3-[(2,3-dihydrothieno[3,4-b]-[1,4]dioxin-2-yl) methoxy]-1-fluoro-1-propanesulfonate, potassium 3-[(2,3-dihydrothieno[3,4-b]-[1,4]dioxin-2-yl) methoxy]-1-methyl-1-propanesulfonate, 3-[(2,3-dihydrothieno[3,4-b]-[1,4]dioxin-2-yl) methoxy]-1-methyl-1-propanesulfonic acid, ammonium 3-[(2,3-dihydrothieno[3,4-b]-[1,4]dioxin-2-yl) methoxy]-1-methyl-1-propane-sulfonate, triethylammonium 3-[(2,3-dihydrothieno[3,4-b]-[1,4]dioxin-2-yl) methoxy]-1-methyl-1-propanesulfonate, etc., as well as combination thereof and derivatives thereof. Each of the above exemplified thiophene monomers may be prepared from thieno[3,4-b]-1,4-dioxin-2-methanol and a branched sultone compound in accordance with a known method (e.g., Journal of Electroanalytical Chemistry, 443, 217 to 226 (1998)).

“Extrinsically” conductive polymers may also be employed, which generally require the presence of a separate counterion that is not covalently bound to the polymer. One example of such an extrinsically conductive polymer is poly(3,4-ethylenedioxythiophene). The counterion may be a monomeric or polymeric anion that counteracts the charge of the conductive polymer. Polymeric anions can, for example, be anions derived from polymeric carboxylic acids (e.g., poly(meth)acrylic acids, such as poly-2-sulfoethyl(meth)acrylate or poly-3-propylsulfo(meth)acrylate; polymaleic acids; etc.); polymeric sulfonic acids (e.g., polystyrene sulfonic acids (“PSS”), polyvinyl sulfonic acids, etc.); and so forth, as well as salts thereof, such as an alkali metal, alkaline earth metal, transition metal, or ammonium salt thereof. Likewise, suitable monomeric anions may be derived from C₁ to C₂₀ alkane sulfonic acids (e.g., dodecane sulfonic acid); aliphatic fluorosulfonic acids (e.g., trifluoromethane sulfonic acid, perfluorobutane sulfonic acid, perfluorooctane sulfonic acid, trifluoromethanesulfonimide, etc.); aliphatic C₁ to C₂₀ carboxylic acids (e.g., 2-ethyl-hexylcarboxylic acid); aliphatic fluorocarboxylic acids (e.g., trifluoroacetic acid or perfluorooctanoic acid); aromatic sulfonic acids optionally substituted by C₁ to C₂₀ alkyl groups (e.g., benzene sulfonic acid, o-toluene sulfonic acid, p-toluene sulfonic acid, or dodecylbenzene sulfonic acid); cycloalkane sulfonic acids (e.g., camphor sulfonic acid); boronic compounds (e.g., tetrafluoroboric acid); phosphoric compounds (e.g., hexafluorophosphoric acid); and so forth, as well as salts thereof, such as an alkali metal, alkaline earth metal, transition metal, or ammonium salt thereof. Particularly suitable counteranions are polymeric anions, such as those derived from a polymeric carboxylic or sulfonic acid (e.g., polystyrene sulfonic acid (“PSS”)). The molecular weight of such compounds typically ranges from about 1,000 to about 2,000,000, and in some embodiments, from about 2,000 to about 500,000.

Whether intrinsically or extrinsically conductive, a pre-polymerized polymer layer may be applied to the anode body in a variety of forms, such as a solution, dispersion, etc. Intrinsically conductive polymers, for example, are preferably applied in the form of a solution while extrinsically conductive polymers are preferably applied in the form of a dispersion.

When a dispersion is employed, the conductive polymer is generally in the form of pre-polymerized conductive particles. Such particles typically have an average size (e.g., diameter) of from about 1 to about 100 nanometers, in some embodiments from about 2 to about 80 nanometers, and in some embodiments, from about 4 to about 50 nanometers. The diameter of the particles may be determined using known techniques, such as by ultracentrifuge, laser diffraction, etc. The shape of the particles may likewise vary. In one particular embodiment, for instance, the particles are spherical in shape. However, it should be understood that other shapes are also contemplated by the present disclosure, such as plates, rods, discs, bars, tubes, irregular shapes, etc. The concentration of the particles in the dispersion may vary depending on the desired viscosity of the dispersion and the particular manner in which the dispersion is to be applied to the capacitor element. Typically, however, the particles constitute from about 0.1 to about 10 wt. %, in some embodiments from about 0.4 to about 5 wt. %, and in some embodiments, from about 0.5 to about 4 wt. % of the dispersion.

The solid electrolyte may be formed from multiple layers, such as inner and/or outer layers. The term “inner” in this context refers to one or more layers that overly the dielectric, whether directly or via another layer (e.g., pre-coat layer). The inner layer(s), for example, typically contain an in-situ polymerized polymer and/or an intrinsically conductive polymer such as described above. One or multiple inner layers may be employed. For example, the solid electrolyte typically contains from 2 to 30, in some embodiments from 4 to 20, and in some embodiments, from about 5 to 15 inner layers (e.g., 10 layers). The solid electrolyte may contain only “inner layers” so that it is essentially formed from the same material, i.e., intrinsically conductive polymers and/or in situ polymerized layers. Nevertheless, in other embodiments, the solid electrolyte may also contain one or more optional “outer” conductive polymer layers that are formed from a different material than the inner layer(s) and overly the inner layer(s). For example, the outer layer(s) may be formed from a dispersion of an extrinsically conductive polymer. In one particular embodiment, the outer layer(s) are formed primarily from such extrinsically conductive polymers in that they constitute about 50 wt. % or more, in some embodiments about 70 wt. % or more, and in some embodiments, about 90 wt. % or more (e.g., 100 wt. %) of a respective outer layer. One or multiple outer layers may be employed. For example, the solid electrolyte may contain from 2 to 30, in some embodiments from 4 to 20, and in some embodiments, from about 5 to 15 outer layers.

An external polymer coating may also be optionally employed that overlies the solid electrolyte. When employed, the external polymer coating typically contains one or more layers formed from pre-polymerized conductive polymer particles such as described above (e.g., dispersion of extrinsically conductive polymer particles). The external coating may be able to further penetrate into the edge region of the capacitor body to increase the adhesion to the dielectric and result in a more mechanically robust part, which may reduce equivalent series resistance and leakage current. Because it is generally intended to improve the degree of edge coverage rather to impregnate the interior of the anode body, the particles used in the external coating may have a larger size than those employed in the outer layers of the solid electrolyte. For example, the ratio of the average size of the particles employed in the external polymer coating to the average size of the particles employed in any dispersion of the solid electrolyte is typically from about 1.5 to about 30, in some embodiments from about 2 to about 20, and in some embodiments, from about 5 to about 15. For example, the particles employed in the dispersion of the external coating may have an average size of from about 80 to about 500 nanometers, in some embodiments from about 90 to about 250 nanometers, and in some embodiments, from about 100 to about 200 nanometers.

If desired, a crosslinking agent may also be employed in the external polymer coating to enhance the degree of adhesion to the solid electrolyte. Typically, the crosslinking agent is applied prior to application of the dispersion used in the external coating. Suitable crosslinking agents are described, for instance, in U.S. Patent Publication No. 2007/0064376 to Merker, et al. and include, for instance, amines (e.g., diamines, triamines, oligomer amines, polyamines, etc.); polyvalent metal cations, such as salts or compounds of Mg, Al, Ca, Fe, Cr, Mn, Ba, Ti, Co, Ni, Cu, Ru, Ce or Zn, phosphonium compounds, sulfonium compounds, etc.

### D. Other Optional Components

If desired, the capacitor element may also contain other layers as is known in the art, such as pre-coat layers, moisture barrier layers, adhesive layers, charge collectors, etc. For example, the capacitor may be applied with a carbon layer (e.g., graphite) and silver layer, respectively. The silver coating may, for instance, act as a solderable conductor, contact layer, and/or charge collector for the capacitor and the carbon coating may limit contact of the silver coating with the solid electrolyte. Such coatings may cover some or all of the solid electrolyte. Various techniques may be employed to apply such layers, such as dipping, brushing, spraying, printing, roll-coating, etc. For instance, in some example embodiments, the carbon layer and the silver layer may be disposed on all or at least a portion of the lower surface, the upper surface, the first end, and the second end of the capacitor element. Without intending to be limited by theory, the present inventors have found that by applying the carbon layer and the silver layer on at least a portion of all of the surfaces of the capacitor element, that the resulting capacitor may demonstrate enhanced electrical properties, such as reduced ESR.

### E. Terminations and Housing

Once formed, the capacitor element may optionally be provided with two or more terminations and/or a housing structure. For example, the capacitor may contain two or more separate and spaced apart anode terminations to which respective exposed anode lead portions are electrically connected. The capacitor may also contain a cathode termination to which the solid electrolyte of the capacitor element is electrically connected. Any conductive material may be employed to form the terminations, such as a conductive metal (e.g., copper, nickel, silver, nickel, zinc, tin, palladium, lead, copper, aluminum, molybdenum, titanium, iron, zirconium, magnesium, and alloys thereof). Particularly suitable conductive metals include, for instance, copper, copper alloys (e.g., copper-zirconium, copper-magnesium, copper-zinc, or copper-iron), nickel, and nickel alloys (e.g., nickel-iron). The thickness of the terminations is generally selected to minimize the thickness of the capacitor. For instance, the thickness of the terminations may range from about 0.05 to about 1 millimeter, in some embodiments from about 0.05 to about 0.5 millimeters, and from about 0.07 to about 0.2 millimeters. One exemplary conductive material is a copper-iron alloy metal plate available from Wieland (Germany). If desired, the surface of the terminations may be electroplated with nickel, silver, gold, tin, etc. as is known in the art to ensure that the final part is mountable to the circuit board. In one particular embodiment, both surfaces of the terminations are plated with nickel and silver flashes, respectively, while the mounting surface is also plated with a tin solder layer. The terminations may be connected to the capacitor element using any technique known in the art, such as resistance welding, laser welding, conductive adhesives, etc.

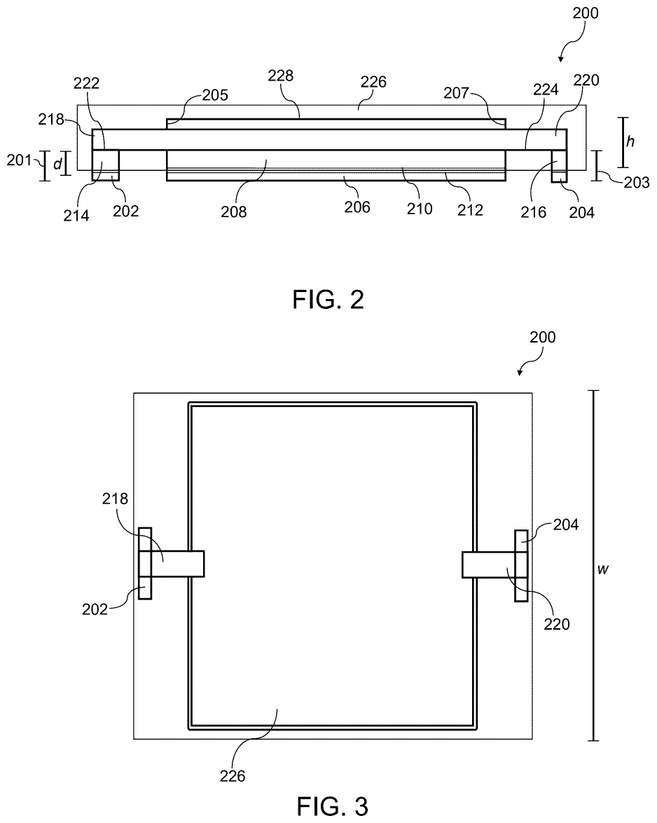

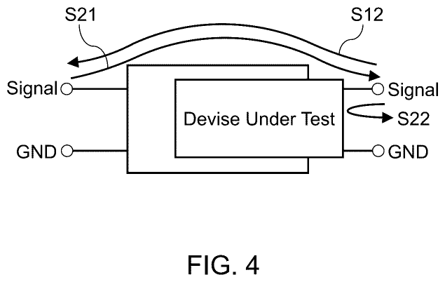

Referring to FIGS. 2-3, which demonstrate a cross-sectional side view and a top view, respectively, of one particular embodiment of a capacitor 200 that contains a cathode termination 206 in electrical connection with the solid electrolyte (not shown) of a capacitor element 208. The capacitor element 208 may contain opposing first and second ends 205 and 207, as well as an opposing lower surface 210 and upper surface 228. The cathode termination 206 is generally planar in the sense that it is formed primarily, if not entirely, from components that extend in the same or substantially the same plane. The cathode termination 206 is positioned adjacent to the lower surface 210 of the capacitor element 208 and is generally parallel thereto. In this particular embodiment, a conductive adhesive 212 connects the cathode termination 206 to the capacitor element 208. The conductive adhesive 212 may include, for instance, conductive metal particles contained with a resin composition, such as an epoxy resin that includes silver particles.

The capacitor 200 may include a first exposed anode lead portion 218 extending from a first end 205 of capacitor element 208 and a second exposed anode lead portion 220 extending from a second opposing end 207 of the capacitor element 208. The exposed anode lead portion 218 is electrically connected to a first anode termination 201 and the exposed anode lead portion 220 is electrically connected to a second anode termination 203. The first anode termination 201 may include a planar portion 202 that is generally parallel with the lower surface 210 of the capacitor element 208 and/or the cathode termination 206. The first anode termination 201 may also contain an upstanding portion 214 that connects the planar portion 202 to the exposed first anode lead portion 218. Likewise, the second anode termination 203 may include a planar portion 204 that is generally parallel with the lower surface 210 of the capacitor element 208 and/or the cathode termination 206. The second anode termination 203 may also contain an upstanding portion 216 that connects the planar portion 204 to the exposed second anode lead portion 220. As noted, the planar portions 202, 204 of the respective anode terminations are planar and generally parallel with the lower surface 210 of the capacitor element 208, and may therefore be located below the respective exposed anode lead portions 218, 220. However, in one embodiment, the first upstanding portion 214, and second upstanding portion 216 may be a thickened or extended portion of the first planar portion 202 and/or second planar portion 204 of the respective anode termination 201, 203. For instance, in one embodiment, the first and/or second anode termination 201, 203 has a height selected based upon a distance “d” from a bottom surface 222, 224 of the exposed anode lead portions 218, 220 to the lower surface 210 of the capacitor element, where the distance “d” typically ranges from about 0.1 to about 1 millimeter, in some embodiments from about 0.2 to about 0.8 millimeters, and in some embodiments, from about 0.3 to about 0.6 millimeters. Of course, the planar portions 202, 204 may also have a height equivalent to the distance “d” such that no upstanding portions are needed. Although not depicted in FIGS. 2-3, the upstanding portions 214, 216 may possess a “U-shape” to further enhance surface contact and mechanical stability of the exposed anode lead portions 218, 220.

The first exposed anode lead portion 218 and second exposed anode lead portion 220 may be electrically connected to the respective anode termination 201, 203 (either directly to planar portions 202, 204 or via upstanding portions 214, 216 as discussed above) using any technique known in the art, such as resistance welding, laser welding, conductive adhesives, etc. The same or different techniques may be employed for each exposed anode lead portion.

In some cases, the capacitor element 208 may have a relatively small thickness or height “h” that ranges from about 0.4 to about 1.5 millimeters, in some embodiments from about 0.5 to about 1.2 millimeters, and in some embodiments, from about 0.6 to about 1 millimeter. Particularly, in one embodiment, such a small height h can further decrease the distance “d”, improving stability of the capacitor and further contributing towards lower ESL of the capacitor. For instance, in one aspect, the distance “d” may have a value based upon the height “h.” In such an aspect, the distance “d” may have a distance that is about 0.1 times the height “h”, such as about 0.2 times, such as about 0.3 times, such as about 0.4 times, such as about 0.5 times the height “h”, decreasing the length of the leads and terminations. The capacitor element 208 may also have a high aspect ratio (ratio of the width “w” of the capacitor element to the height “h”), due at least in part to the small thickness discussed above. Such high aspect ratios may be about 2 or greater, such as about 3 or greater, such as about 4 or greater, such as about 5 or greater, such as about 6 or greater. Particularly, as discussed above, the present inventors have found that a capacitor having such a shape and orientation can further contribute to the low ESL properties of the capacitor, as well as forming a small, low profile capacitor.

If desired, the capacitor element may be encapsulated within a housing so that at least a portion of the termination(s) (e.g., first anode termination, the second anode termination, and cathode termination) are exposed for mounting onto a circuit board. Referring again to FIGS. 2-3, for instance, the capacitor element 208 may be encapsulated within a housing 226 so that at least a lower surface of the planar portion 202 of the anode termination 201, the planar portion 204 of the anode termination 203, and/or the planar cathode termination 206 are exposed. In some cases, only these surfaces are exposed. The housing is typically formed from a thermoset resin, such as an epoxy resin.

### III. Example Circuits

As described above, the solid electrolytic capacitor according to examples of the present disclosure may be used as a feedthrough capacitor for a variety of applications and circuits. FIGS. 5-22 provide example circuits including an SEFC according to examples of the present disclosure. FIGS. 5-22 provide example circuits for purposes of illustration and discussion. Those of ordinary skill in the art, using the disclosures provided herein, will understand that the SEFC according to examples of the present disclosure may be used in a variety of applications and/or electrical circuits without deviating from the scope of the present disclosure.

FIG. 5A depicts an example schematic of a bias line for a transistor Q1 501 according to example embodiments of the present disclosure. As indicated in FIG. 5A, an SEFC 502 can be used to provide filtered biasing to the transistor. The SEFC 402 can include one or more capacitors and one or more resistors. The use of the SEFC 502 in the circuit can simplify the circuit design while offering improved high-frequency filtering and EMI suppression performance, according to example embodiments of the present disclosure. The SEFC 502 may be configured to provide equivalent filtering performance while reducing circuit complexity.

FIG. 5B depicts performance characteristics of the bias line of FIG. 5A, illustrating the benefits of using the SEFC. FIG. 5B plots return loss S₂₁ in decibels (dB) along the vertical axis, and frequency in megahertz (MHz) along the horizontal axis. Curve 350 shows performance as originally designed (e.g., the one or more capacitors and the one or more resistors). Curve 352 shows the performance of a modified version of the circuit with resistors removed, indicating a partial simplification of the network. Curve 354 shows the performance of the bias line when the portion of the circuit (e.g., the bias line) is replaced with the SEFC 502 according to example embodiments of the present disclosure. As illustrated in FIG. 5B, the SEFC configuration (curve 354) demonstrates improved performance across a broad frequency range, particularly at both lower and higher frequencies, relative to the configurations using discrete components. The SEFC 502 can replace individual components in the bias line of the circuit in FIG. 5A, thereby reducing board space, parasitic effects, and manufacturing complexity.

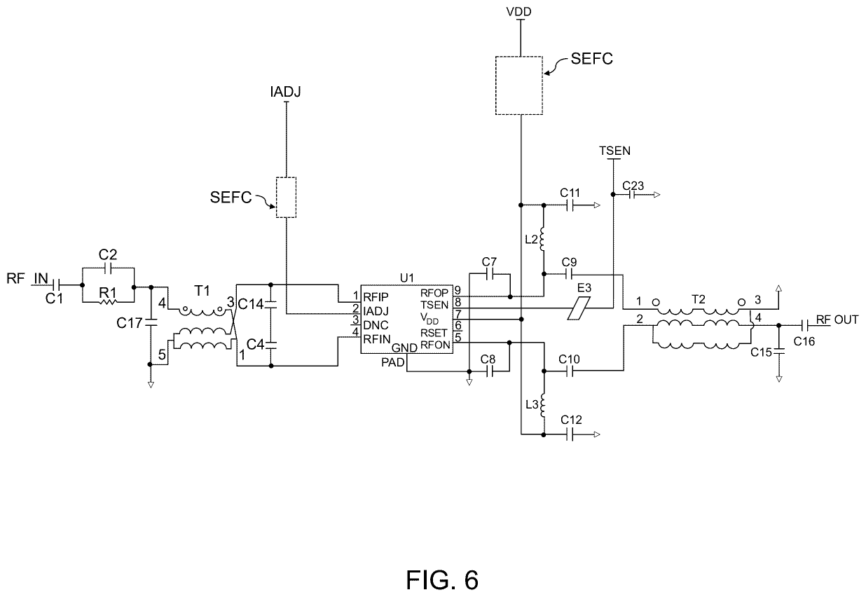

FIG. 6 depicts an example application of an SEFC that may be used to replace passive components in bias lines and/or power supply lines for an RF amplifier, according to example embodiments of the present disclosure. One or more portions of the circuit, such as the variable bias line and/or the Vdd power supply line, may be replaced with an SEFC. Such replacement can reduce component count, simplify circuit layout, and improve performance, in accordance with example aspects of the present disclosure.

On the variable bias line (IADJ), an SEFC 601 may be used to integrate the filtering and protective functionality of the discrete components into a compact structure, thereby simplifying the layout and improving overall RF performance. On the Vdd power supply line, a conventional design includes multiple filtering and decoupling components. This portion of the circuit may also be replaced by an SEFC 602. The integration of the SEFC (601, 602) in place of these discrete components can simplify the circuit layout while maintaining or improving overall performance.

Accordingly, FIG. 6 illustrates how the SEFC, according to example embodiments, may be integrated into existing RF amplifier designs to replace multiple passive filtering and protection components, resulting in improved system performance, reliability, and manufacturability.

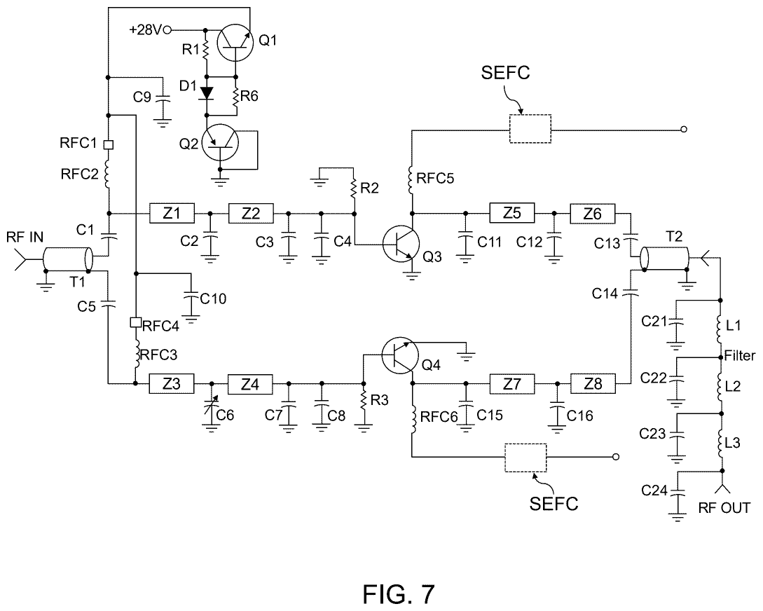

FIG. 7 depicts an example application of an SEFC that may be used to replace passive components in bias lines and/or power supply lines for an RF amplifier, according to example embodiments of the present disclosure. As shown, one or more portions of the RF amplifier circuit may be replaced with one or more SEFCs (701, 702) for use of voltage conditioning. By consolidating these elements into a single SEFC, the overall size of the circuit may be reduced, and the layout may be simplified. The use of SEFCs (701, 702) for voltage conditioning as illustrated in FIG. 7 represents an efficient approach to integrating multiple passive elements in RF amplifier biasing and power supply networks, enabling enhanced electrical performance with fewer discrete components.

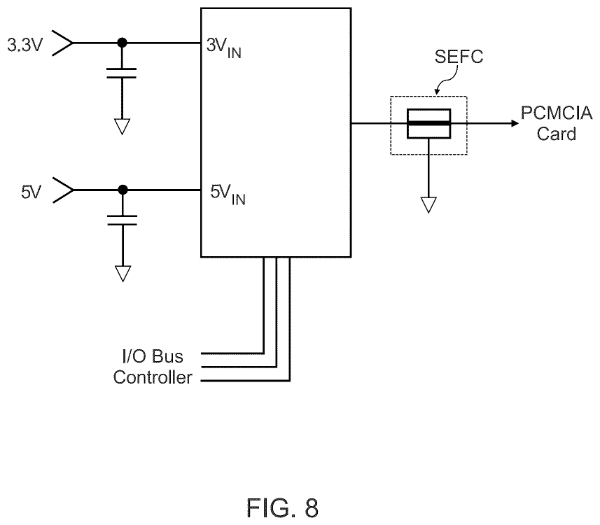

FIG. 8 depicts an example use of an SEFC in, for instance, a TEMPEST (telecommunications and electrical machinery protected from emanations security) application, according to example embodiments of the present disclosure. As shown, the SEFC 801 may be positioned at the output stage of a power supply circuit that provides regulated power to a PCMCIA card. The system receives both 3.3V and 5V input supplies, and these supply voltages are delivered to a power management IC, which is controlled by signals from an I/O bus controller. The SEFC 801 as depicted in FIG. 8, is disposed between the power management IC and the PCMCIA card, provide shielding and a wide spectrum of filtering on power supply lines.

As described above, the SEFC 801 may be an output filter for all power conversion topologies. (e.g., to provide low pass filtering response). For instance, the SEFC 801 may provide output filtering for boost converters, buck converters, other DC to DC converters, inverters, etc. As shown in FIG. 8, the SEFC 801 may be applied in any system needing shielding and broadband filtering on power lines, including secure I/O or communication interfaces like PCMCIA cards.

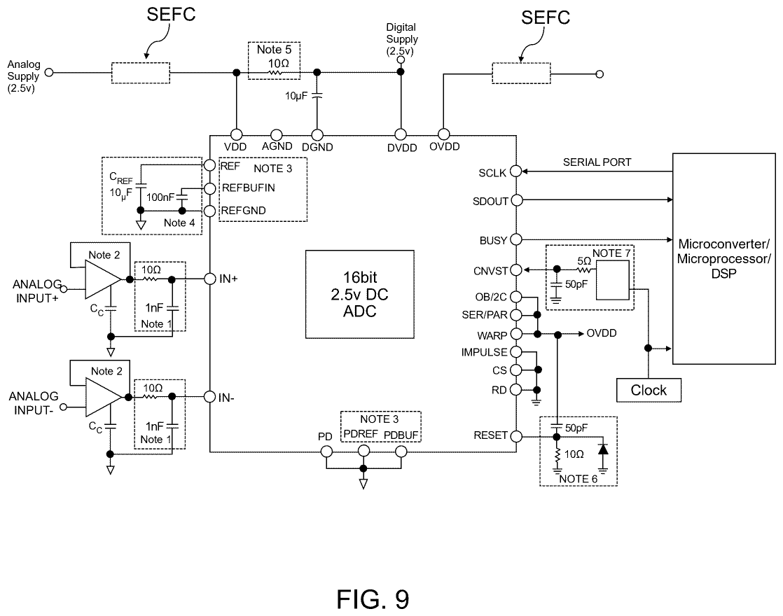

FIG. 9 depicts that the SEFC may be used as part of a digital and/or analog interface. For instance, the SEFC may be used as part of an analog supply. As shown, the SEFC 901 may be integrated into the analog supply path, which may, for example, deliver a 2.5V analog supply to a high-resolution analog-to-digital converter (ADC), such as a 16-bit ADC. In this configuration, the SEFC 901 can replace multiple discrete capacitors typically used to decouple and stabilize the analog power supply. By doing so, the SEFC 901 can reduce power supply noise and enhance signal fidelity in sensitive analog front ends.

The SEFC 902 may also be used as part of the digital interface supply path, which may include a 2.5V or 3.3V digital supply that powers communication and control circuitry between the ADC and a microcontroller, microprocessor, or digital signal processor (DSP). In this portion of the circuit, the SEFC 902 may replace discrete bypass capacitors and filter components that are conventionally used to suppress digital switching noise and maintain signal integrity across digital I/O lines. The interface(s) may be for an ADC, such as the 16-bit ADC. SEFCs may replace one or more groups of discrete passive components, and as a result, simplify the circuit design and reduce component count. By integrating an SEFC (901/902) into the analog and/or digital supply paths, improved power integrity and noise suppression may be achieved in a compact and efficient form.

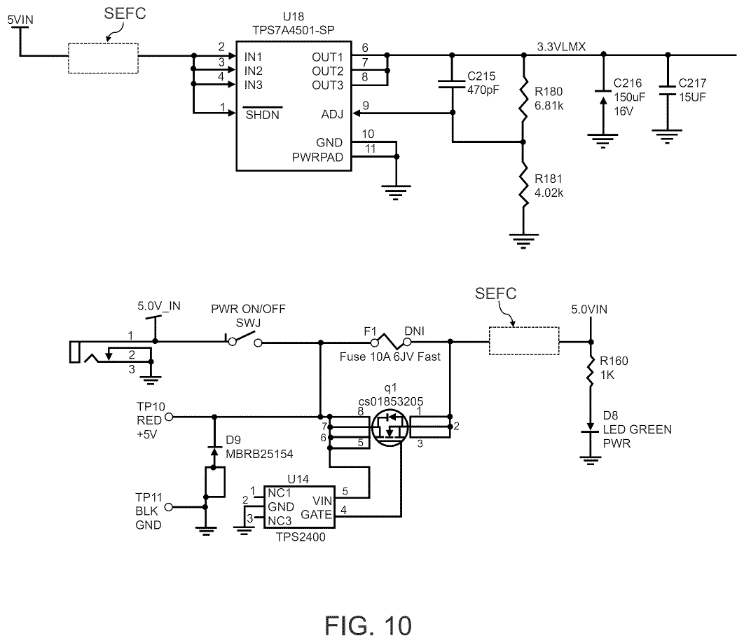

FIG. 10 depicts that the SEFC may be used as part of the power supply (e.g., bias line, power supply line) for various active components. As shown, the SEFC (1001, 1002) may be incorporated into a power supply or bias line that provides regulated voltage to one or more active components, such as a microprocessor, microcontroller, voltage regulator, or other low-power integrated circuit. For instance, the SEFC (1001, 1002) may be used as part of the power supply line for certain low power microprocessor applications.

As shown in FIG. 10, the SEFC 1001 may be positioned in the power input path of a voltage regulator or other active devices. For instance, the SEFC 1001, shown in the upper portion of FIG. 10, may be a potential replacement for discrete filtering components positioned at the input of a voltage regulator (U18), which generates a regulated output voltage from a 5V input supply. The SEFC 1002, shown in the lower portion of FIG. 10, may be used in the power supply line of other circuits, such as a power switch or controller. For example, the SEFC may be used to filter the 5.0V supply input.

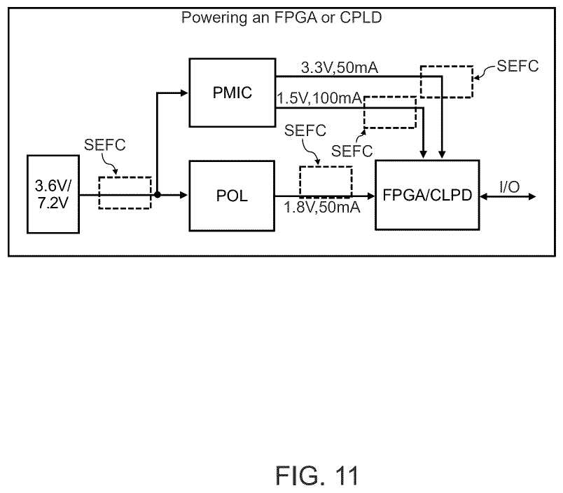

FIGS. 11-13 depict example locations of an SEFC in power supply systems for FPGA or other processor cores, including point of load applications. FIGS. 11-13 depict multiple possible locations of the SEFC for purposes of illustration and discussion. The SEFC may be located at one, some, or all of the illustrated locations without deviating from the scope of the present disclosure.

FIG. 11 depicts an example power supply system for powering an FPGA, or a CPLD, in a consumer application. As shown, a primary voltage source, supplying between 3.6V and/or 7.2V, feeds both a point-of-load (POL) converter and a power management integrated circuit (PMIC). The PMIC generates regulated outputs of 3.3V at 50 mA and 1.5V at 100 mA, while the POL provides 1.8V at 50 mA. SEFCs (1101, 1102, 1103, 1104) may be positioned at various locations, including the inputs and outputs of the PMIC and POL, as well as directly at the FPGA or CPLD's power input nodes and I/O interface.

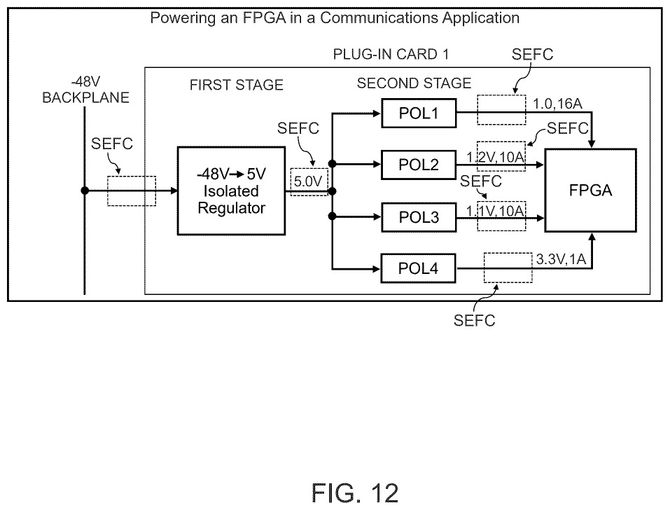

FIG. 12 depicts an example power supply system for powering a FPGA in a communications application. The system receives input from a −48V backplane, which is first converted to 5V by an isolated DC-DC regulator forming a first power conversion stage. The 5V intermediate rail then feeds multiple point-of-load (POL) converters in a second stage, each generating a specific supply voltage for the FPGA: 1.0V at 16 A, 1.2V at 10 A, 1.1V at 10 A, and 3.3V at 1 A. SEFCs (1201, 1202, 1203, 1204, 1205, 1206) may be positioned at the input of the isolated regulator, at the 5V output of the first stage, at the inputs to each POL converter, and at the outputs of each POL converter prior to connection with the FPGA.

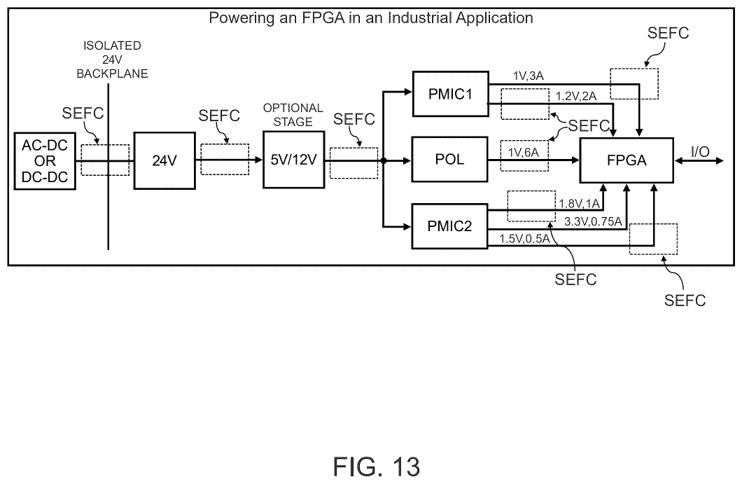

FIG. 13 depicts an example power system for powering an FPGA in an industrial application. The system includes an isolated 24V backplane source derived from either an AC-DC or DC-DC front-end converter. An optional intermediate stage generates 5V or 12V for additional flexibility. The power is then supplied to PMICs and POL converters that provide final regulated voltages for the FPGA, including 1V at 3 A, 1.2V at 2.2 A, 1.8V at 1 A, 3.3V at 0.75 A, 1.5V at 0.5 A, and 1.8V at 0.8 A. SEFCs (1301, 1302, 1303, 1304, 1305, 1306, 1307) may be positioned at multiple points in this architecture, including the input to the 24V, the input and output of the optional intermediate stages, the inputs and outputs of the PMICs and POL converters, and the final outputs to the FPGA core and I/O.

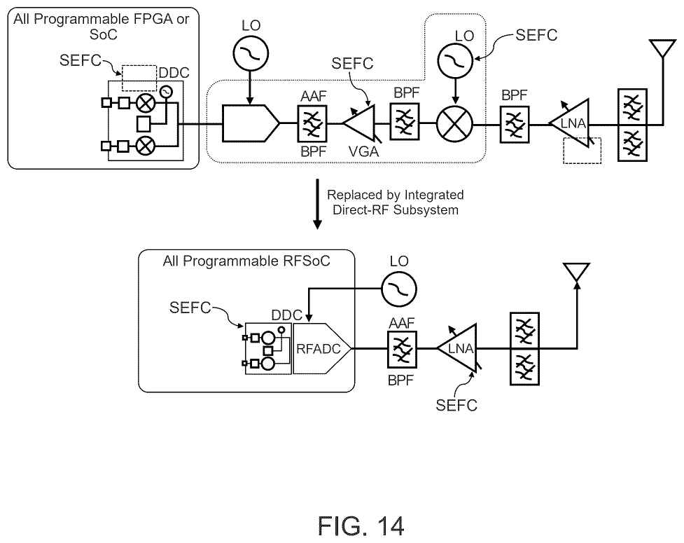

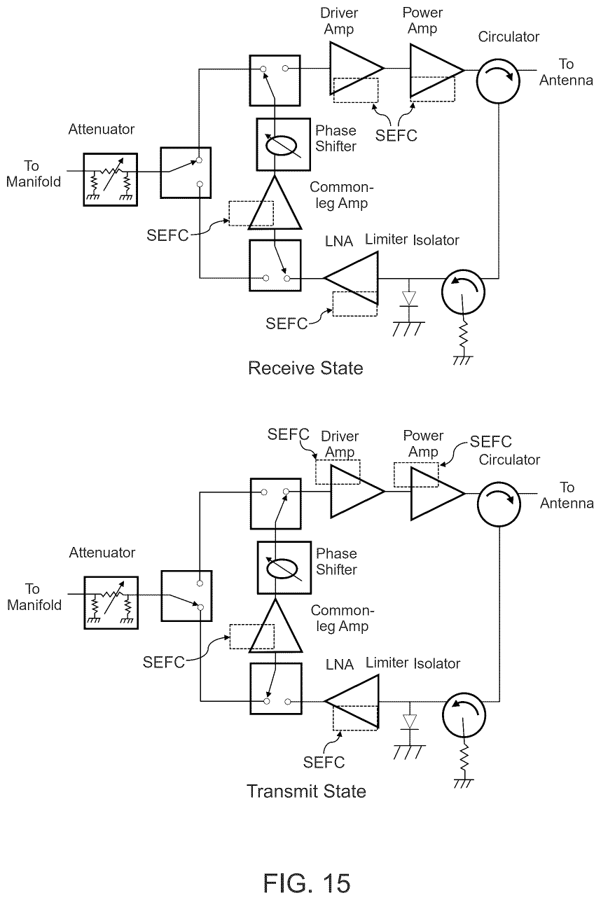

FIGS. 14-15 illustrate example uses of the SEFC to provide power conditioning for components used in an RF circuit. The SEFC may be used in the power supply line and/or bias line for various amplifiers, oscillators, etc. to provide broad band filtering and to provide high power quality to the devices.

The upper portion of FIG. 14 depicts a system using a conventional all-programmable FPGA or SoC coupled with discrete RF components such as local oscillators (LO), anti-aliasing filters (AAF), variable gain amplifiers (VGA), bandpass filters (BPF), mixers, and low-noise amplifier (LNA). SEFCs (1401, 1402, 1403) may be applied at key points including the digital downconverter (DDC) of the all-programmable FPGA or SoC, and along the bias or supply lines for remaining external RF components, such as the VGA and LO. The lower portion of FIG. 14 shows an integrated all-programmable RFSoC architecture where the direct-RF subsystem replaces many of the discrete RF components. The all-programmable RFSoC coupled with local oscillators (LO), anti-aliasing filters (AAF) and bandpass filters (BPF), and low-noise amplifier (LNA). SEFCs (1404, 1405) may be applied at key points including the digital downconverter (DDC), RF analog-to-digital converter (RFADC) of the all-programmable RFSoC, and along the bias or supply lines for remaining external RF components, such as the LNA.

FIG. 15 depicts the use of SEFCs in a power and signal conditioning architecture for an RF circuit in both receive state and transmit state. In the receive state, SEFCs are positioned along power supply or bias lines to components including attenuators, phase shifters, driver amplifiers, power amplifiers, common-leg amplifiers, low-noise amplifiers (LNAs), and circulators. As shown in FIG. 15, the SEFCs (1501, 1502, 1503) are positioned at the amplifiers. These SEFCs (1501, 1502, 1503) serve to reduce conducted noise and improve the quality of the bias or supply voltages delivered to RF stages. In the transmit state, SEFCs (1504, 1505, 1506, 1507) similarly condition the power for driver amplifiers, power amplifiers, common-leg amplifiers, low-noise amplifiers (LNAs), ensuring clean and stable power delivery to support high-performance RF transmission.

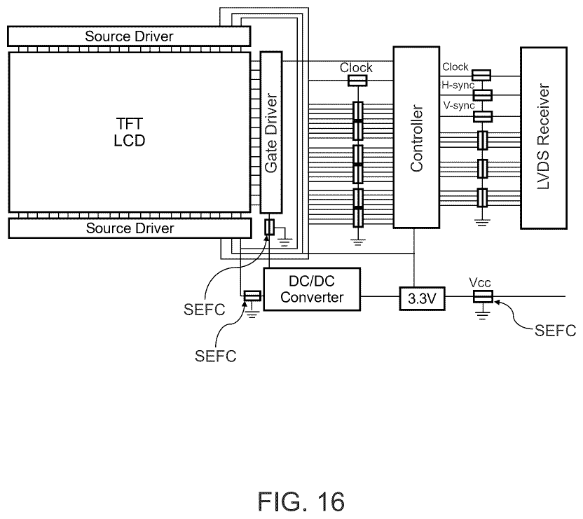

FIG. 16 depicts example uses of the SEFC, according to example embodiments of the present disclosure, in a display system application, specifically in the power delivery network for a TFT-LCD panel. The SEFC 1601 may be positioned at the inputs to the gate driver circuits to provide power. The SEFC 1601 may provide power to gate driver circuits for a variety of applications without deviating from the scope of the present disclosure. The SEFC 1602 may also be positioned on the supply lines feeding the DC/DC converter that generates power for the LCD gate driver circuits. The SEFC 1603 can further be positioned at the output of the 3.3V regulator that supplies power to a controller and LVDS receiver. This arrangement of SEFCs provides filtering to enhance the power integrity delivered to timing, control, and driver circuitry in the display system.

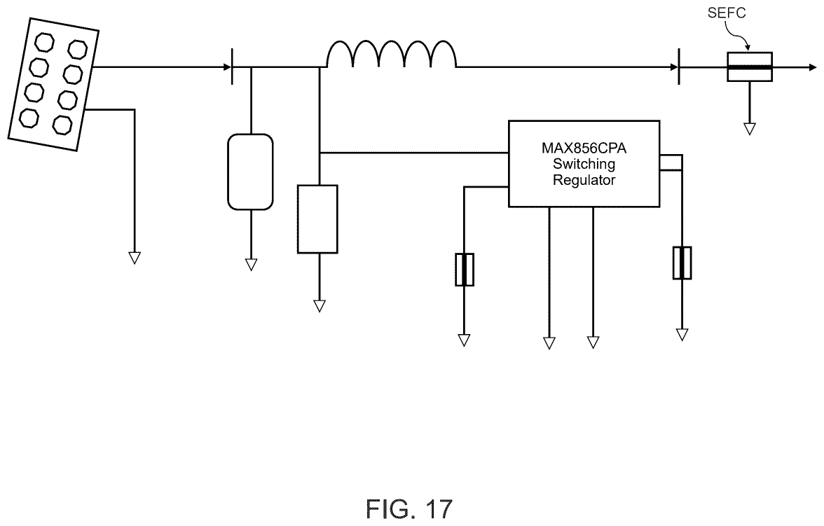

FIG. 17 depicts example use of an SEFC as an output filter for a power conversion system from a solar power supply according to example embodiments of the present disclosure. As shown in FIG. 17, a solar cell array can deliver input power to a power conversion system. The power conversion system includes a switching regulator, such as a MAX856CPA switching regulator, to convert the variable DC input from the solar panel into a regulated DC output. One or more SEFCs 1701 may be positioned at the output of the power conversion system, downstream of the switching regulator, to provide final-stage filtering.

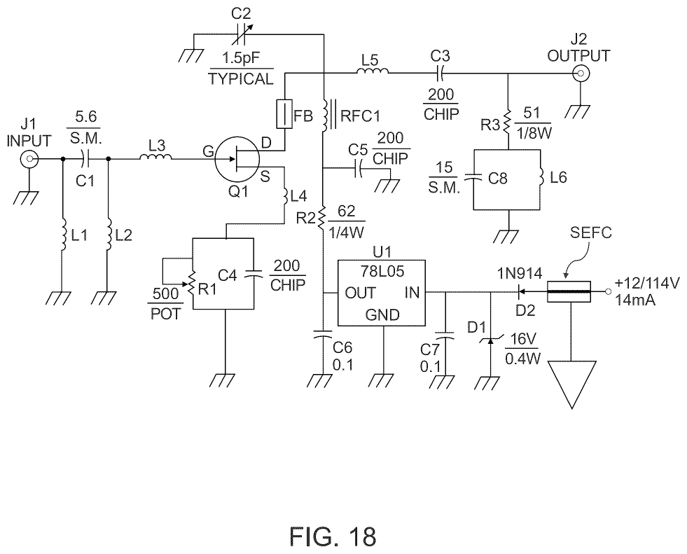

FIG. 18 depicts example use of an SEFC on an input line for a power decoupling field-effect transistor (FET) amplifier (e.g., GaAs FET amplifier) used in, for instance, RF applications according to example embodiments of the present disclosure. As shown, the FET amplifier may include an input port (J1) and an output port (J2), with associated matching and bias circuitry designed to optimize RF performance. A +12V/14V DC supply is connected through an SEFC 1801 to the circuit, delivering power at a nominal current of approximately 14 mA. The SEFC 1801 is positioned upstream of the protection diodes (D1, D2), voltage regulator (U1, e.g., a 78L05), and associated decoupling capacitors (C6, C7). The SEFC arrangement can be effectively applied in RF amplifier systems to improve power decoupling and reduce noise coupling.

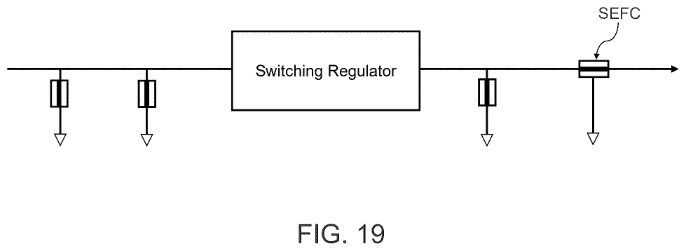

FIG. 19 depicts an SEFC to provide output filtering, for instance, for a voltage regulator (e.g., switching regulator) according to example embodiments of the present disclosure. As shown, a power input line is coupled to the input of a switching regulator, which may comprise any form of DC-DC converter. One or more SEFCs 1901 are coupled between the input power line and ground. The switching regulator is configured to generate a regulated output voltage at its output terminal. At the output side of the switching regulator, one or more SEFCs 1901 are coupled between the output line and ground. Additionally, at the output side of the switching regulator, an SEFC 1901 is connected in-line with the regulated voltage output path. By placing the SEFC at the output of the switching regulator, the system improves the quality of the regulated voltage delivered to subsequent loads, reducing electromagnetic interference (EMI) and improving power integrity.

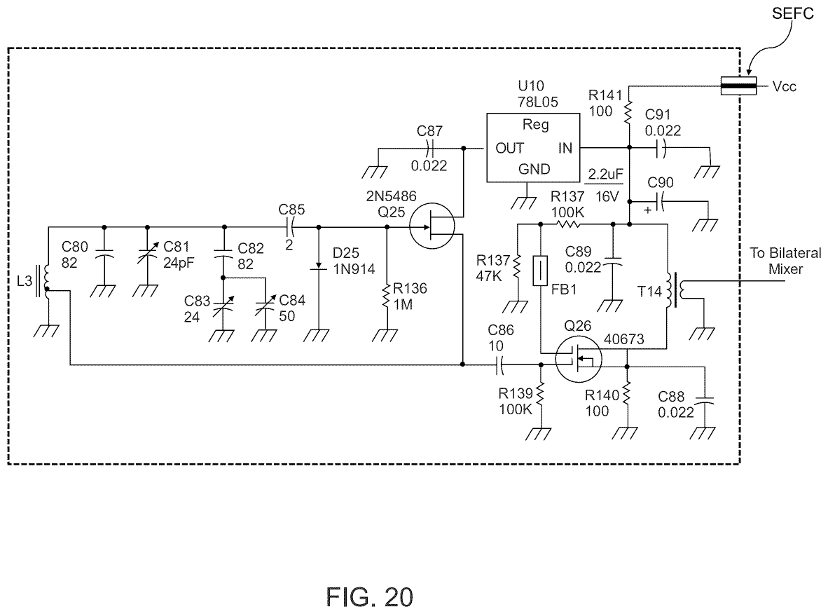

FIG. 20 depicts an example used of an SEFC on an input power supply line for a frequency controller according to example embodiments of the present disclosure. The SEFC may be used to condition the power supply input of the frequency controller. As shown, the SEFC 2001 is disposed on the Vcc supply line providing power to a frequency-generating circuit, such as a variable frequency oscillator (VFO) operating in the 6-6.35 MHz range. The SEFC 2001 is positioned between the incoming Vcc power source and the internal circuitry, which includes transistors, resistive elements, capacitors, and an integrated voltage regulator (U10).

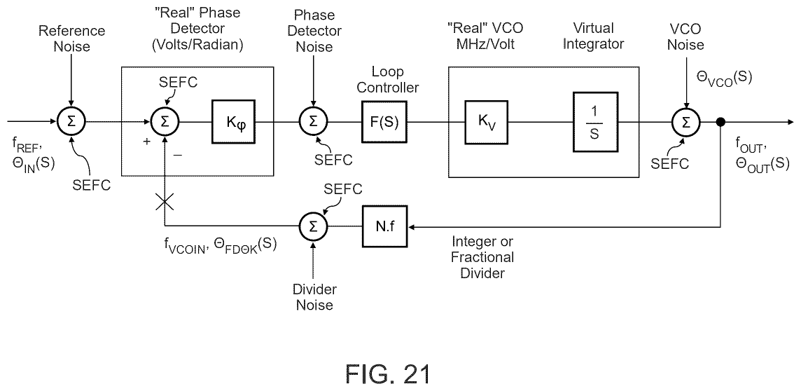

FIG. 21 depicts an example phase-locked loop (PLL) circuit according to example embodiments of the present disclosure. As illustrated, the SEFC (2101, 2102, 2103, 2104, 2105) may be used for filtering at any of the summing nodes (e.g., sigma nodes) in the PLL circuit. In particular, the SEFC (2101, 2102, 2103, 2104, 2105) may be applied at the summing node associated with the reference input, the phase detector, the loop controller input, the VCO output, or the divider feedback path. The SEFC may be configured to selectively filter or compensate error signals or noise at these locations to enhance overall loop performance.

As shown in FIG. 21, the PLL circuit receives a reference input signal characterized by frequency f_{REF} and phase Θ_{IN}(S). The reference input signal is introduced at the corresponding summing node. The reference input signal is then provided to a phase detector, which may be a “real” phase detector. The phase detector may produce an output in volts per radian, with the phase detector gain represented as Ko. The SEFC 2102 may be provided at the summing node associated with the phase detector input, allowing filtering or compensation of error signals or noise introduced at this point. The output of the phase detector is combined at a summing node with phase detector noise and provided to a loop controller block F(S). SEFC 2103 may be applied at the input of the loop controller to further filter or compensate noise or error signals present at this summing node. The loop controller output is applied to a voltage-controlled oscillator (VCO), such as a “real” VCO, having gain Kv (MHz/Volt) followed by a virtual integrator 1/S. VCO noise may be introduced at the VCO output summing node, and SEFC may be applied at this location for filtering or compensation purposes. The VCO output is fed back through an integer or fractional divider block, N·f, where N is the divider ratio. The divider path may include divider noise, introduced at a summing node, where SEFC 1204 may also be applied to filter or compensate such noise. The divided signal is returned to the phase detector input for comparison with the reference signal.

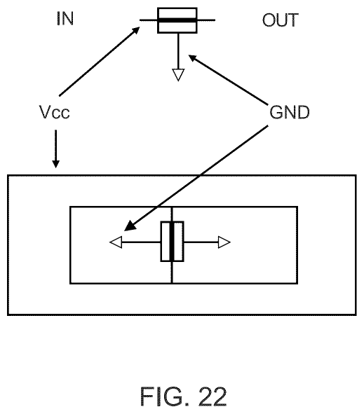

FIG. 22 depicts two different ways to connect the SEFC in a circuit, according to example embodiments of the present disclosure. In one example, one side of the SEFC 2201 is coupled to ground (or reference), while the other side is connected to an input and/or an output signal path. This configuration may provide improved noise filtering performance by effectively shunting unwanted noise or error signals to ground, but may have a lower current handling capability due to the single-ended connection. In another example, both sides of the SEFC 2201 are connected to ground (or reference). This arrangement may provide greater current handling capability, making it suitable for applications where higher current levels are present, but may reduce filtering capability. In either configuration, the SEFC 2201 may be integrated within a larger circuit or system and configured according to design requirements to optimize noise reduction, current handling, or other performance parameters.

Example aspects of the present disclosure are set forth below. Any of the below features or examples may be used in combination with any of the embodiments or features provided in the present disclosure.

In an aspect, the present disclosure provides an example circuit. In some implementations, the example circuit includes an input or output structure configured to provide a signal to or from an active electronic component. In some implementations, the example circuit includes a feedthrough capacitor in the input or output structure, the feedthrough capacitor includes a solid electrolytic capacitor, and the solid electrolytic capacitor includes a capacitor element that includes an anode body, a dielectric that overlies the anode body, and a solid electrolyte that overlies the dielectric, the capacitor element defines opposing first and second ends and an upper surface and opposing lower surface, a first exposed anode lead portion extends from the first end of the capacitor element in a lateral direction a second exposed anode lead portion extends from the second end of the capacitor element in a lateral direction.

In some implementations of the example circuit, the feedthrough capacitor exhibits an S₂₁ parameter (absolute value) of from about 20 dB to about 70 dB at a frequency band ranging from 1 kHz to 1 GHz.

In some implementations of the example circuit, the feedthrough capacitor exhibits an S₂₁ parameter (absolute value) of from about 30 dB to about 70 dB at a frequency band ranging from 1 MHz to 1 GHz.

In some implementations of the example circuit, the feedthrough capacitor exhibits impedance of from about 10 mohms to about 100 mohms at a frequency band ranging from about 1 MHz to about 100 MHz.

In some implementations of the example circuit, the feedthrough capacitor further includes a first anode termination that is in electrical connection with the first exposed anode lead portion; a second anode termination that is in electrical connection with the second exposed anode lead portion; and a cathode termination that is in electrical connection with the solid electrolyte.

In some implementations of the example circuit, the anode body includes tantalum and the dielectric includes tantalum pentoxide.

In some implementations of the example circuit, the solid electrolyte includes a conductive polymer.

In some implementations of the example circuit, the conductive polymer includes poly(3,4-ethylenedioxythiophene), or a derivative thereof.

In some implementations of the example circuit, a continuous anode lead extends through the first end and the second end of the capacitor element, thereby defining the first exposed anode lead portion and the second exposed anode lead portion.

In some implementations of the example circuit, the signal is a power signal.

In some implementations of the example circuit, the input or output structure is a bias line for an active component.

In some implementations of the example circuit, the input or output structure is a power supply line for an active component.

In some implementations of the example circuit, the active component is one or more of a transistor, an amplifier, a processor, a core, a controller, or a switch.

In some implementations of the example circuit, the input or output structure is at least a part of a filter circuit for a power conversion circuit.

In some implementations of the example circuit, the power conversion circuit is one or more of a buck converter, a boost converter, or an inverter.

In some implementations of the example circuit, the input or output structure is at least a part of a filter circuit for a voltage regulator.

In some implementations of the example circuit, the input or output structure provides the signal to a driver circuit.

In some implementations of the example circuit, the circuit includes a frequency control circuit.

In some implementations of the example circuit, the circuit includes a phase locked loop (PLL) circuit.

In another aspect, the present disclosure provides an example circuit. In some implementations, the example circuit includes an input or output structure configured to provide a signal or power to or from an active electronic component.

In some implementations, the example circuit includes a feedthrough capacitor in the input or output structure, the feedthrough capacitor includes a solid electrolytic capacitor, solid electrolytic capacitor includes a capacitor element that includes an anode body, a dielectric that overlies the anode body, and a solid electrolyte that overlies the dielectric, the capacitor exhibits an S₂₁ parameter (absolute value) of from about 20 dB to about 70 dB at a frequency band ranging from 1 kHz to 1 GHZ and/or impedance of from about 10 mohms to about 100 mohms at a frequency band ranging from about 1 MHz to about 100 MHz.

In some implementations of the example circuit, the capacitor element defines opposing first and second ends and an upper surface and opposing lower surface, wherein a first exposed anode lead portion extends from the first end of the capacitor element in a lateral direction a second exposed anode lead portion extends from the second end of the capacitor element in a lateral direction.

In some implementations of the example circuit, a continuous anode lead extends through the first end and the second end of the capacitor element, thereby defining the first exposed anode lead portion and the second exposed anode lead portion.

In some implementations of the example circuit, the capacitor further includes a first anode termination that is in electrical connection with the first exposed anode lead portion; a second anode termination that is in electrical connection with the second exposed anode lead portion; and a cathode termination that is in electrical connection with the solid electrolyte.

In some implementations of the example circuit, the anode body includes tantalum and the dielectric includes tantalum pentoxide.

In some implementations of the example circuit, the solid electrolyte includes a conductive polymer.

In some implementations of the example circuit, the conductive polymer includes poly(3,4-ethylenedioxythiophene), or a derivative thereof.

In some implementations of the example circuit, the signal is a power signal.

In some implementations of the example circuit, the input or output structure is a bias line for an active component.

In some implementations of the example circuit, the input or output structure is a power line for an active component.

In some implementations of the example circuit, the active component is one or more of a transistor, an amplifier, a processor, a core, a controller, or a switch.

In some implementations of the example circuit, the input or output structure is at least a part of a filter circuit for a power conversion circuit.

In some implementations of the example circuit, the power conversion circuit is one or more of a buck converter, a boost converter, or an inverter.

In some implementations of the example circuit, the input or output structure is at least a part of a filter circuit for a voltage regulator.

In some implementations of the example circuit, the input or output structure provides the signal to a driver circuit.

In some implementations of the example circuit, the circuit comprises a frequency control circuit.

In some implementations of the example circuit, the circuit comprises a phase locked loop (PLL) circuit.

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only, and is not intended to limit the disclosure so further described in such appended claims.

What is claimed is:

1. A circuit comprising:
an input or output structure configured to provide a signal to or from an active electronic component;
a feedthrough capacitor in the input or output structure, the feedthrough capacitor comprising a solid electrolytic capacitor;
wherein the solid electrolytic capacitor comprises a capacitor element that includes an anode body, a dielectric that overlies the anode body, and a solid electrolyte that overlies the dielectric, wherein the capacitor element defines opposing first and second ends and an upper surface and opposing lower surface, wherein a first exposed anode lead portion extends from the first end of the capacitor element in a lateral direction a second exposed anode lead portion extends from the second end of the capacitor element in a lateral direction.

2. The circuit of claim 1, wherein the feedthrough capacitor exhibits an S₂₁ parameter (absolute value) of from about 20 dB to about 70 dB at a frequency band ranging from 1 kHz to 1 GHz.

3. The circuit of claim 1, wherein the feedthrough capacitor exhibits an S₂₁ parameter (absolute value) of from about 30 dB to about 70 dB at a frequency band ranging from 1 MHz to 1 GHz.

4. The circuit of claim 1, wherein the feedthrough capacitor exhibits impedance of from about 10 mohms to about 100 mohms at a frequency band ranging from about 1 MHz to about 100 MHz.

5. The circuit of claim 1, wherein the feedthrough capacitor further includes:
a first anode termination that is in electrical connection with the first exposed anode lead portion;
a second anode termination that is in electrical connection with the second exposed anode lead portion; and
a cathode termination that is in electrical connection with the solid electrolyte.

6. The circuit of claim 1, wherein the anode body includes tantalum and the dielectric includes tantalum pentoxide.

7. The circuit of claim 1, wherein the solid electrolyte includes a conductive polymer.

8. The circuit of claim 7, wherein the conductive polymer includes poly(3,4-ethylenedioxythiophene), or a derivative thereof.

9. The circuit of claim 1, wherein a continuous anode lead extends through the first end and the second end of the capacitor element, thereby defining the first exposed anode lead portion and the second exposed anode lead portion.

10. The circuit of claim 1, wherein the signal is a power signal.

11. The circuit of claim 1, wherein the input or output structure is a bias line for an active component.

12. The circuit of claim 1, wherein the input or output structure is a power supply line for an active component.

13. The circuit of claim 12, wherein the active component is one or more of a transistor, an amplifier, a processor, a core, a controller, or a switch.

14. The circuit of claim 1, wherein the input or output structure is at least a part of a filter circuit for a power conversion circuit.

15. The circuit of claim 14, wherein the power conversion circuit is one or more of a buck converter, a boost converter, or an inverter.

16. The circuit of claim 1, wherein the input or output structure is at least a part of a filter circuit for a voltage regulator.

17. The circuit of claim 1, wherein the input or output structure provides the signal to a driver circuit.

18. The circuit of claim 1, wherein the circuit comprises a frequency control circuit.

19. The circuit of claim 1, wherein the circuit comprises a phase locked loop (PLL) circuit.

20. A circuit comprising:
an input or output structure configured to provide a signal or power to or from an active electronic component;
a feedthrough capacitor in the input or output structure, the feedthrough capacitor comprising a solid electrolytic capacitor;
wherein the solid electrolytic capacitor comprises a capacitor element that includes an anode body, a dielectric that overlies the anode body, and a solid electrolyte that overlies the dielectric, wherein the capacitor exhibits an S₂₁ parameter (absolute value) of from about 20 dB to about 70 dB at a frequency band ranging from 1 kHz to 1 GHz and/or impedance of from about 10 mohms to about 100 mohms at a frequency band ranging from about 1 MHz to about 100 MHz.
